(19) United States
(12) Patent Application Publication
(10) Pub. No.: US 2012/0230409 A1
(43) Pub. Date: Sep. 13, 2012

(54) DECODED PICTURE BUFFER MANAGEMENT

(75) Inventors: Ying Chen, San Diego, CA (US); Marta Karczewicz, San Diego, CA (US)

(73) Assignee: QUALCOMM INCORPORATED, San Diego, CA (US)

(21) Appl. No.: 13/412,387

(22) Filed: Mar. 5, 2012

Related U.S. Application Data
(60) Provisional application No. 61/449,805, filed on Mar. 7, 2011.
(60) Provisional application No. 61/484,630, filed on May 10, 2011.
(60) Provisional application No. 61/546,868, filed on Oct. 13, 2011.

(51) Int. Cl. H04N 7/36

(52) U.S. Cl. 375/240.15; 375/E07.255

(57) ABSTRACT

The example techniques described in this disclosure are generally related to decoded picture buffer management. One or more pictures stored in the decoded picture buffer may be usable for prediction, and others may not. Pictures that are usable for prediction may be referred to as reference pictures. The example techniques described herein may determine whether a reference picture, that is currently indicated to be usable for inter-prediction, should be indicated to be unusable for inter-prediction.

This application claims the benefit of U.S. Provisional Application No. 61/449,805, filed Mar. 7, 2011, U.S. Provisional Application No. 61/484,630, filed May 10, 2011, and U.S. Provisional Application No. 61/546,868, filed Oct. 13, 2011, the contents of which are incorporated herein by reference in their entireties.

### TECHNICAL FIELD

This disclosure is related to video encoding and decoding, and more particularly, to managing a decoded picture buffer.

### BACKGROUND

A video coder, such as a video encoder or a video decoder, includes a decoded picture buffer (DPB), which stores one or more decoded pictures. One or more of these decoded pictures may be used as reference pictures. A reference picture may be a picture that is usable for inter-prediction purposes to encode other pictures. For example, the video coder may use one or more reference pictures to inter-predict a video block of a current picture. In other words, a current picture is coded with reference to one or more reference pictures stored in the decoded picture buffer.

### SUMMARY

In general, this disclosure describes example techniques to determine whether a picture that is currently indicated to be usable as a reference picture should be indicated as unusable as a reference picture. For example, the techniques may utilize a reference picture window scheme that includes reference pictures with different temporal level values with constraints as to which pictures should be indicated as usable or unusable as reference pictures based on the temporal level values of the pictures and coding order of the pictures.

In one example, the disclosure describes a method for video coding that includes coding a picture with reference to one or more reference pictures stored in a decoded picture buffer (DPB), determining a temporal level value of the coded picture, and identifying a set of reference pictures from the reference pictures stored in the DPB, each of which is currently indicated as usable for inter-prediction and has a temporal level value equal to or greater than the temporal level value of the coded picture. The method also includes determining that a coding order of a reference picture in the set of reference pictures is earlier than a coding order of any other reference pictures in the set of reference pictures, and determining that the reference picture is no longer usable for inter-prediction.

In one example, the disclosure describes a video coding device that includes a decoded picture buffer (DPB) configured to store reference pictures that are currently indicated as usable for inter-prediction, and a video coder, coupled to the DBP. The video coder is configured to code a picture with reference to one or more reference pictures stored in the DPB, determine a temporal level value of the coded picture, and identify a set of reference pictures from the reference pictures stored in the DPB, each of which is currently indicated as usable for inter-prediction and has a temporal level value equal to or greater than the temporal level value of the coded picture. The video coder is also configured to determine that a coding order of a reference picture in the set of reference pictures is earlier than a coding order of any other reference pictures in the set of reference pictures, and determine that the reference picture is no longer usable for inter-prediction.

In one example, the disclosure describes a computer-readable storage medium comprising instructions that cause one or more processors to code a picture with reference to one or more reference pictures stored in a decoded picture buffer (DPB), determine a temporal level value of the coded picture, and identify a set of reference pictures from the reference pictures stored in the DPB, each of which is currently indicated as usable for inter-prediction and has a temporal level value equal to or greater than the temporal level value of the coded picture. The instructions also cause the one or more processors to determine that a coding order of a reference picture in the set of reference pictures is earlier than a coding order of any other reference pictures in the set of reference pictures, and determine that the reference picture is no longer usable for inter-prediction.

In one example, the disclosure describes a video coding device that includes a decoded picture buffer configured to store reference pictures that are currently indicated as usable for inter-prediction. The video coding device also includes means for coding a picture with reference to one or more reference pictures stored in the DPB, means for determining a temporal level value of the coded picture, and means for identifying a set of reference pictures from the reference pictures stored in the DPB, each of which is currently indicated as usable for inter-prediction and has a temporal level value equal to or greater than the temporal level value of the coded picture. The video coding device further includes means for determining that a coding order of a reference picture in the set of reference pictures is earlier than a coding order of any other reference pictures in the set of reference pictures, and means for determining that the reference picture is no longer usable for inter-prediction.

The details of one or more aspects of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram illustrating an example video encoding and decoding system.

FIG. 2 is a conceptual diagram illustrating an example video sequence that includes pictures in display order

FIG. 3 is a block diagram illustrating an example of a video encoder that may implement techniques in accordance with one or more aspects of this disclosure.

FIG. 4 is a block diagram illustrating an example of a video decoder that may implement techniques in accordance with one or more aspects of this disclosure.

FIG. 5 is a flowchart illustrating an example operation in accordance with one or more aspects of this disclosure.

FIG. 6 is a flowchart illustrating an example operation in accordance with one or more aspects of this disclosure.

### DETAILED DESCRIPTION

The example techniques described in this disclosure are directed to managing a decoded picture buffer (DPB). A video encoder and a video decoder (commonly referred to as a “video coder”) each include a decoded picture buffer. The DPB stores decoded pictures which may potentially be used for inter-predicting a current picture. The video coder may indicate which pictures, stored in the DPB, can be used for inter-prediction purposes. For example, the video coder may mark a picture as “used for reference,” or “unused for reference.” Pictures that are marked as “used for reference” are pictures that can be used for inter-predicting a picture, and pictures that are marked as “unused for reference” are reference pictures that cannot be used for inter-predicting a picture. Pictures that are indicated to be used for inter-prediction (e.g., marked as “used for reference”) may be referred to as reference pictures.

In some examples, even pictures that are marked as “unused for reference” may remain stored in the DPB because the moment when these pictures are to be displayed has not occurred yet. Once pictures marked as “unused for reference” are outputted (e.g., displayed by a device that includes a video decoder or signaled by a device that includes a video encoder), pictures marked as “unused for reference” may be removed from the DPB. However, such removal may not be required in every example.

Aspects of this disclosure are related to techniques that determine which pictures in a decoded picture buffer should be indicated as unusable for reference (e.g., marked as “unused for reference”). In some examples, these techniques may be implicit techniques, and may be applied by both a video encoder and a video decoder (each being generally referred to as video coder). For example, a video decoder may determine which picture is no longer usable for inter-prediction without receiving explicit signaling in the encoded video bitstream that defines the manner in which the video decoder should determine which picture is unusable for inter-prediction. Similarly, the video decoder may determine which picture is no longer usable for inter-prediction without receiving explicit signaling in the encoded video bitstream that indicates which picture is no longer usable for inter-prediction.

As described in more detail, a video coder may utilize temporal level values and coding order of the pictures, indicated by picture number values, in a window scheme to determine whether a picture is usable or unusable as a picture for inter-prediction. In the window scheme, pictures that are currently marked as “used for reference” (e.g., reference pictures) in the DPB are part of the window. When a picture is coded (e.g., encoded by a video encoder or decoded by a video decoder), the techniques may determine whether a reference picture that is currently in the window should now be determined to be unusable for inter-prediction. The techniques may perform the determination based on the temporal level values of the reference pictures in the window and the coded picture, and a coding order of the reference pictures.

If the techniques determine that a picture currently in the window is no longer usable as a reference picture, the techniques may indicate as such. For example, the techniques may mark such a picture that is currently in the window as “unused for reference” in the DPB, and this picture may no longer be part of the window. In some examples when a picture is removed from the window, the techniques may replace the removed picture with the coded picture. For example, the techniques may indicate that the coded picture is usable for inter-prediction by, for example, marking the coded picture as “used for reference” in the DPB. The coded picture may then be part of the window.

If the techniques determine that no reference picture should be removed from the window, the techniques may indicate that the coded picture is not usable for inter-prediction (e.g., mark the coded picture as “unused for reference”). In other words, when the techniques determine that no reference picture should be removed from the window, the pictures identified in the window remain the same (e.g., no modification to the window), and the coded picture is marked as “unused for reference.” The techniques may then proceed with the next coded picture (i.e., slide the window to the next coded picture).

There may be various examples of the implicit technique that the video coder may employ to determine whether a reference picture (e.g., a picture currently indicated to be usable for inter-prediction) is unusable as a reference picture (e.g., unusable for inter-prediction). As one example of the implicit technique, the video coder may determine that a reference picture, that is currently indicated as being usable for inter-prediction, is no longer usable for inter-prediction when (1) a temporal level value of the reference picture is equal to or greater than the temporal level value of the coded picture, and (2) a coding order for the reference picture is earlier than a coding order of all reference pictures that have temporal level values that are equal to or greater than the temporal level value of the coded picture. As another example of the implicit technique, the video coder may determine that a reference picture, that is currently indicated as being usable for inter-prediction, is no longer usable for inter-prediction when (1) a temporal level value of the reference picture is equal to or greater than the temporal level value of the coded picture, (2) no other reference picture has a temporal level value greater than the temporal level value of the reference picture, and (3) a coding order for the reference picture is earlier than a coding order of all reference pictures that have temporal level values that are equal to the temporal level value of the reference picture.

The implicit techniques described above may be related to short-term reference pictures; however, aspects of this disclosure are not so limited. Short-term reference pictures may refer to reference pictures that do not need to be stored in the DPB for a relatively long period of time for predicting purposes. Long-term reference pictures, on the other hand, may refer to reference pictures that need to be stored in the DPB for a relatively long period of time as these reference pictures may be used repeatedly and for inter-predicting pictures that are much further away in coding order. In general, for the techniques of this disclosure, the manner in which the video coder manages the long-term reference pictures in the DPB may be immaterial. For example, the techniques of this disclosure may function in a substantially similar manner regardless of the number of long-term reference pictures stored in the DPB.

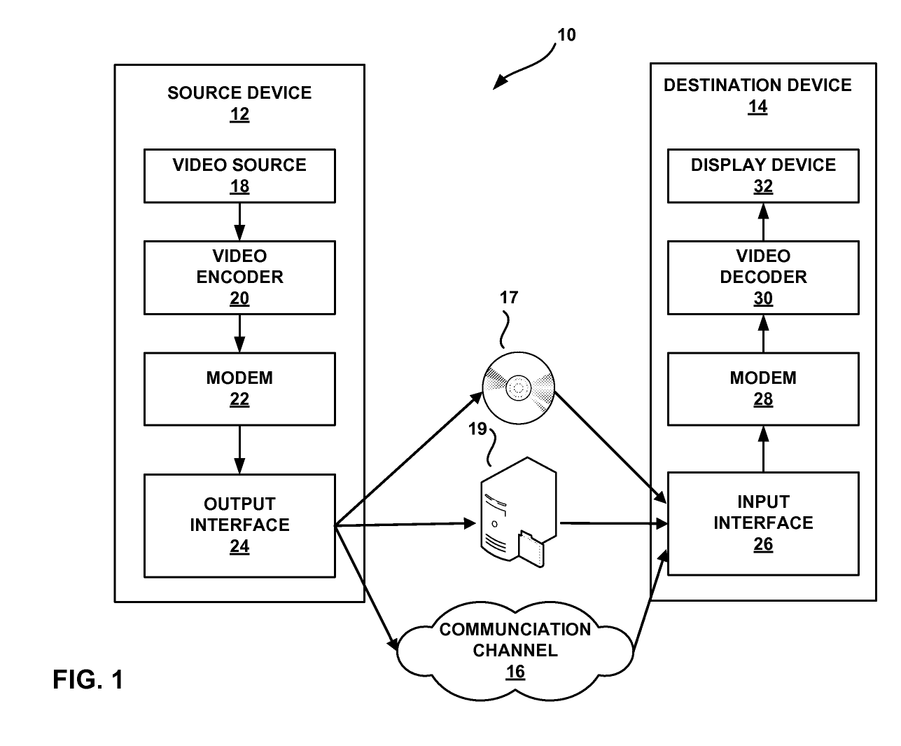

FIG. 1 is a block diagram illustrating an example video encoding and decoding system 10 that may utilize techniques for efficient coding including techniques to indicate which pictures are usable for inter-prediction and which pictures are unusable for inter-predication in accordance with examples of this disclosure. In general, the term “picture” may refer to a portion of a video, and may be used interchangeably with the term “frame.” In aspects of this disclosure, one or more blocks within a picture may be predicted from one or more blocks in other pictures, or one or more blocks within in the same picture. Intra-prediction refers to predicting a block in a picture from one or more blocks within the same picture. Inter-prediction refers to predicting a block in a picture from one or more blocks in a different picture or pictures.

As described in more detail, the example techniques of this disclosure are related to determining whether a picture, which can currently be used for inter-prediction, should no longer be used for prediction. The techniques also include determining whether a coded picture can be used for inter-prediction or cannot be used for inter-prediction. Pictures that can be used for inter-prediction may be referred to as reference pictures because such pictures are used as reference for inter-predicting blocks within a current picture.

As shown in FIG. 1, system 10 includes a source device 12 that generates encoded video for decoding by destination device 14. Source device 12 and destination device 14 may each be an example of a video coding device. Source device 12 may transmit the encoded video to destination device 14 via communication channel 16 or may store the encoded video on a storage medium 17 or a file server 19, such that the encoded video may be accessed by the destination device 14 as desired.

Source device 12 and destination device 14 may comprise any of a wide variety of devices, including desktop computers, notebook (i.e., laptop) computers, tablet computers, set-top boxes, telephone handsets such as so-called smartphones, televisions, cameras, display devices, digital media players, video gaming consoles, or the like. In many cases, such devices may be equipped for wireless communication. Hence, communication channel 16 may comprise a wireless channel, a wired channel, or a combination of wireless and wired channels suitable for transmission of encoded video data. Similarly, the file server 19 may be accessed by the destination device 14 through any standard data connection, including an Internet connection. This may include a wireless channel (e.g., a Wi-Fi connection), a wired connection (e.g., DSL, cable modem, etc.), or a combination of both that is suitable for accessing encoded video data stored on a file server.

Techniques, in accordance with examples described in this disclosure, may be applied to video coding in support of any of a variety of multimedia applications, such as over-the-air television broadcasts, cable television transmissions, satellite television transmissions, streaming video transmissions, e.g., via the Internet, encoding of digital video for storage on a data storage medium, decoding of digital video stored on a data storage medium, or other applications. In some examples, system 10 may be configured to support one-way or two-way video transmission to support applications such as video streaming, video playback, video broadcasting, and/or video telephony.

In the example of FIG. 1, source device 12 includes a video source 18, video encoder 20, a modulator/demodulator (modem) 22 and an output interface 24. In source device 12, video source 18 may include a source such as a video capture device, such as a video camera, a video archive containing previously captured video, a video feed interface to receive video from a video content provider, and/or a computer graphics system for generating computer graphics data as the source video, or a combination of such sources. As one example, if video source 18 is a video camera, source device 12 and destination device 14 may form so-called camera phones or video phones. However, the techniques described in this disclosure may be applicable to video coding in general, and may be applied to wireless and/or wired applications.

The captured, pre-captured, or computer-generated video may be encoded by video encoder 20. The encoded video information may be modulated by modem 22 according to a communication standard, such as a wireless communication protocol, and transmitted to destination device 14 via output interface 24. Modem 22 may include various mixers, filters, amplifiers or other components designed for signal modulation. Output interface 24 may include circuits designed for transmitting data, including amplifiers, filters, and one or more antennas.

The captured, pre-captured, or computer-generated video that is encoded by the video encoder 20 may also be stored onto a storage medium 17 or a file server 19 for later consumption. The storage medium 17 may include Blu-ray discs, DVDs, CD-ROMs, flash memory, or any other suitable digital storage media for storing encoded video. The encoded video stored on the storage medium 17 may then be accessed by destination device 14 for decoding and playback.

File server 19 may be any type of server capable of storing encoded video and transmitting that encoded video to the destination device 14. Example file servers include a web server (e.g., for a website), an FTP server, network attached storage (NAS) devices, a local disk drive, or any other type of device capable of storing encoded video data and transmitting it to a destination device. The transmission of encoded video data from the file server 19 may be a streaming transmission, a download transmission, or a combination of both. The file server 19 may be accessed by the destination device 14 through any standard data connection, including an Internet connection. This may include a wireless channel (e.g., a Wi-Fi connection), a wired connection (e.g., DSL, cable modem, Ethernet, USB, etc.), or a combination of both that is suitable for accessing encoded video data stored on a file server.

Destination device 14, in the example of FIG. 1, includes an input interface 26, a modem 28, a video decoder 30, and a display device 32. Input interface 26 of destination device 14 receives information over channel 16, and modem 28 demodulates the information to produce a demodulated bitstream for video decoder 30. The demodulated bitstream may include a variety of syntax information generated by video encoder 20 for use by video decoder 30 in decoding video data. Such syntax may also be included with the encoded video data stored on a storage medium 17 or a file server 19. As one example, the syntax may be embedded with the encoded video data, although aspects of this disclosure should not be considered limited to such a requirement. The syntax information defined by video encoder 20, which is also used by video decoder 30, may include syntax elements that describe characteristics and/or processing of prediction units (PUs), coding units (CUs) or other units of coded video, e.g., video slices, video pictures, and video sequences or groups of pictures (GOPs). Each of video encoder 20 and video decoder 30 may form part of a respective encoder-decoder (CODEC) that is capable of encoding or decoding video data.

Display device 32 may be integrated with, or external to, destination device 14. In some examples, destination device 14 may include an integrated display device and also be configured to interface with an external display device. In other examples, destination device 14 may be a display device. In general, display device 32 displays the decoded video data to a user, and may comprise any of a variety of display devices such as a liquid crystal display (LCD), a plasma display, an organic light emitting diode (OLED) display, or another type of display device.

In the example of FIG. 1, communication channel 16 may comprise any wireless or wired communication medium, such as a radio frequency (RF) spectrum or one or more physical transmission lines, or any combination of wireless and wired media. Communication channel 16 may form part of a packet-based network, such as a local area network, a wide-area network, or a global network such as the Internet. Communication channel 16 generally represents any suitable communication medium, or collection of different communication media, for transmitting video data from source device 12 to destination device 14, including any suitable combination of wired or wireless media. Communication channel 16 may include routers, switches, base stations, or any other equipment that may be useful to facilitate communication from source device 12 to destination device 14.

Video encoder 20 and video decoder 30 may operate according to a video compression standard, such as the emerging High Efficiency Video Coding (HEVC) standard or the ITU-T H.264 standard, alternatively referred to as MPEG-4, Part 10, Advanced Video Coding (AVC). The HEVC standard is currently under development by the ITU-T/ISO/IEC Joint Collaborative Team on Video Coding (JCT-VC). The techniques of this disclosure, however, are not limited to any particular coding standard. Other examples include MPEG-2 and ITU-T H.263.

Although not shown in FIG. 1, in some aspects, video encoder 20 and video decoder 30 may each be integrated with an audio encoder and decoder, and may include appropriate MUX-DEMUX units, or other hardware and software, to handle encoding of both audio and video in a common data stream or separate data streams. If applicable, MUX-DEMUX units may conform to the ITU H.223 multiplexer protocol, or other protocols such as the user datagram protocol (UDP).

Video encoder 20 and video decoder 30 each may be implemented as any of a variety of suitable encoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure.

Each of video encoder 20 and video decoder 30 may be included in one or more encoders or decoders, either of which may be integrated as part of a combined encoder/decoder (CODEC) in a respective device. In some instances, video encoder 20 and video decoder 30 may be commonly referred to as a video coder that codes information (e.g., pictures and syntax elements). The coding of information may refer to encoding when the video coder corresponds to video encoder 20. The coding of information may refer to decoding when the video coder corresponds to video decoder 30.

Furthermore, the techniques described in this disclosure may refer to video encoder 20 signaling information such as syntax elements. When video encoder 20 signals information, the techniques of this disclosure generally refer to any manner in which video encoder 20 provides the information. For example, when video encoder 20 signals syntax elements to video decoder 30, it may mean that video encoder 20 transmitted the syntax elements to video decoder 30 via output interface 24 and communication channel 16, or that video encoder 20 stored the syntax elements via output interface 24 on storage medium 17 and/or file server 19 for eventual reception by video decoder 30. In this way, signaling from video encoder 20 to video decoder 30 should not be interpreted as requiring transmission from video encoder 20 that is immediately received by video decoder 30, although this may be possible. Rather, signaling from video encoder 20 to video decoder 30 should be interpreted as any technique with which video encoder 20 provides information for eventual reception by video decoder 30.

In the examples described in this disclosure, video encoder 20 may encode a portion of a picture of the video data, referred to as a video block, using intra-prediction or inter-prediction. The video block may be portion of a slice, which may be a portion of the picture. For purposes of illustration, the example techniques described in this disclosure are generally described with respect to video blocks of slices. For instance, an intra-predicted video block of a slice means that the video block within the slice is intra-predicted (e.g., predicted with respect to neighboring blocks within the slice or picture that includes the slice). Similarly, an inter-predicted video block of a slice means that the video block within the slice is inter-predicted (e.g., predicted with respect to one or two video blocks of reference picture or pictures).

For an intra-predicted video block, referred to as an intra-coded video block, video encoder 20 predicts and encodes the video block with respect to other portions within the picture. Video decoder 30 may decode the intra-coded video block without referencing any other picture of the video data. For an inter-predicted video block, referred to as an inter-coded video block, video encoder 20 predicts and encodes the video block with respect to one or two portions within one or two other pictures. These other pictures are referred to as reference pictures, which may also be pictures that are predicted with reference to yet other reference picture or pictures, or intra-predicted pictures.

Inter-predicted video blocks within a slice may include video blocks that are predicted with respect to one motion vector that points to one reference picture, or two motion vectors that point to two different reference pictures. When a video block is predicted with respect to one motion vector pointing to one reference picture, that video block is considered to be uni-directionally predicted. When a video block is predicted with respect to two motion vectors pointing to two different reference pictures, that video block is considered to be bi-directionally predicted. In some examples, the motion vectors may also include reference picture information (e.g., information that indicates to which reference picture the motion vectors point). However, aspects of this disclosure are not so limited.

Video encoder 20 and video decoder 30 may each include a decoded picture buffer (DPB). The respective DPBs may store decoded pictures, and one or more of these decoded pictures may be used for inter-prediction purposes (e.g., uni-directional prediction or bi-directional prediction). For example, as part of the encoding process, video encoder 20 may store a decoded version of a just encoded picture in its DPB. The decoded version is decoded and reconstructed to reproduce the picture in the pixel domain. Video encoder 20 may then utilize this decoded version for inter-predicting a block of a current picture. For example, video encoder 20 may utilize one or more blocks of the decoded picture as references for the purposes of encoding a block of the current picture. In some instances, after decoding a received picture, video decoder 30 may store the decoded version of the received picture in its DPB because video decoder 30 may need to use this decoded picture for inter-predicting subsequent pictures. For example, video decoder 30 may utilize one or more blocks of the decoded picture as references for the purposes of decoding a block of a subsequent picture.

However, not all pictures stored in respective DPBs may be used for inter-predicting. In this disclosure, pictures that can be used for inter-prediction may be referred to as reference pictures as these pictures are used as references for encoding or decoding a block of a current picture. Video encoder 20 and video decoder 30 may manage the DPB to indicate which pictures are reference pictures and which pictures are not reference pictures.

For example, video encoder 20 and video decoder 30 may mark pictures stored in their respective DPBs as “used for reference” or “unused for reference.” Pictures that are marked as “used for reference” are reference pictures, and those marked as “unused for reference” are not. Those pictures that are marked as “used for reference” (e.g., reference pictures) may be used for inter-predicting, and those that are marked as “unused for reference” may not be used for inter-predicting. Marking pictures as “used for reference” or “unused for reference” is provided for illustration purposes only and should not be considered limiting. In general, video encoder 20 and video decoder 30 may implement any technique to indicate whether a picture is usable or unusable for inter-prediction.

As discussed in more detail below, the techniques of this disclosure may be related to managing the decoded picture buffers (DPBs) of video encoder 20 and video decoder 30. For instance, the examples described in this disclosure may provide one or more techniques by which video encoder 20 and video decoder 30 may determine whether a picture is usable for inter-prediction or unusable for inter-prediction. These example techniques may be implicit techniques, which may mean that video encoder 20 and video decoder 30 may be able to implement these techniques without transmitting or receiving explicit signaling that includes instructions for how to determine whether a picture is usable or unusable for inter-prediction. The implicit techniques may also allow video encoder 20 and video decoder 30 to implement techniques to determine which pictures in the DPB are usable for inter-prediction and which ones are not usable for inter-prediction without transmitting or receiving explicit signaling that indicates which pictures in the DPB are usable for inter-prediction and which ones are not.

In one or more examples, the implicit techniques may rely on a reference picture window scheme. For example, video encoder 20 and video decoder 30 may maintain respective windows. The respective windows may include identifiers for which pictures are usable for inter-prediction. In some examples, these identifiers may be the picture order count (POC) values of the pictures, although, aspects of this disclosure are not so limited. In some examples, picture number values, sometimes referred to as frame number values, may be used instead of or in addition to POC values.

POC values define the order in which the pictures are outputted or presented (e.g., on a display). For example, a picture with a lower POC value is displayed earlier than a picture with a higher POC value. However, it may be possible for the picture with the higher POC value to be encoded or decoded (e.g., coded) earlier than the picture with the lower POC value. Picture number values, also referred to as frame number values, define the order in which the pictures are coded (e.g., encoded or decoded). For example, a picture with a lower picture number value is coded earlier than a picture with a higher picture number value. However, it may be possible for the picture with higher picture number value to be displayed earlier than the picture with the lower picture number value.

For video encoder 20, for a current picture that is being encoded for transmission, video encoder 20 may determine whether that picture should be a picture that is usable for subsequent inter-prediction (e.g., inter-predicting subsequent pictures). Similarly, for video decoder 30, for a current picture that is being decoded for subsequent display, video decoder 30 may determine whether that picture should be a picture that is usable for subsequent inter-prediction.

For both video encoder 20 and video decoder 30, if the current picture is to be used for inter-prediction, video encoder 20 and video decoder 30 may determine whether a current reference picture (e.g., a picture indicated to be usable for inter-prediction) should no longer be used for inter-prediction. If there is a reference picture that should no longer be used for inter-prediction, its identifier may be removed from the reference picture window, and the identifier for the current picture may be placed into the window. Video encoder 20 and video decoder 30 may then proceed with the next coded picture (e.g., move the window to the next picture), and perform similar functions. If the current picture is not to be used for inter-prediction, video encoder 20 and video decoder 30 may proceed to the next picture and perform similar functions.

There are various examples of the implicit techniques that video encoder 20 and video decoder 30 may utilize to determine whether a picture should be or should not be used for inter-prediction. In making this determination, the techniques may rely on temporal level values and coding order, which may be indicated by picture number values. The temporal level value, sometimes referred to as a temporal_id, for a current picture is a hierarchical value that indicates which pictures can possibly be a reference picture for the current picture (e.g., can be used for inter-prediction). Only pictures whose temporal level value is less than or equal to the temporal level value for the current picture can be used as reference pictures for the current picture (e.g., can be used for inter-predicting the current picture). As one example, assume that the temporal level value (e.g., temporal_id) for a current inter-predicted picture is 2. In this example, pictures with temporal level values of 0, 1, or 2 can be reference pictures that are usable to decode the current inter-predicted picture, and pictures with temporal level values of 3 or more cannot be reference pictures that are usable to decode the current inter-predicted picture.

Coding order for the pictures refers to the order in which the pictures are coded (e.g., encoded or decoded). For instance, as described above, each picture is associated with a picture number value that indicates an order of when the picture is coded. In examples described in this disclosure, video encoder 20 and video decoder 30 may determine the coding order of the pictures based on their respective picture number values.

In the implicit techniques described in this disclosure, a video coder (e.g., video encoder 20 and/or video decoder 30) may code (e.g., encode or decode) a current picture. The video coder may determine the temporal level value for the coded picture. For example, video encoder 20 may set the temporal level value of coded picture such that the temporal level value of the coded picture is greater than or equal to the temporal level value of the one or more reference pictures used to code the picture. Video encoder 20 may set the temporal level value in such a manner because only pictures whose temporal level values are less than or equal to the temporal level value of a picture can be used as reference pictures for the picture that is to be coded.

In some examples, video encoder 20 may signal the temporal level value of the picture as a syntax element in the network abstraction layer (NAL) unit header of the picture. In these examples, to determine the temporal level value of the picture, video decoder 30 may receive the temporal level value for the picture from the NAL unit of the header of the picture. The syntax element for the temporal level value may be referred to as temporal_id.

In general, the temporal level value may specify a temporal identifier for the NAL unit. The value of the temporal level value may be the same for all NAL units of an access unit. The access unit may be considered as a picture. For example, the decoding of each access unit may result in one decoded picture. In some examples, when an access unit includes any NAL unit with nal_unit_type equal to 5, the temporal level value for that access unit may be equal to 0.

There may be some constraints on the temporal level values. For example, for each access unit auA with temporal_id equal to tIdA, an access unit auB with temporal_id equal to tIdB, where tIdB is less than or equal to tIdA may not be referenced by inter prediction when there exists an access unit auC with temporal_id equal to tIdc, where tIdC is less than tIdB, and where the access unit auC follows the access unit auB and precedes the access unit auA in decoding order. This constrain on temporal level values is provided for illustration purposes and should not be considered limiting. In some examples, video encoder 20 may set the temporal level values for the pictures, and include them in the NAL units based on any potential constrains for determining the temporal level values.

In the example techniques described in this disclosure, the video coder may determine the temporal level values of the reference pictures that are stored in the DPB. In other words, the video coder may determine the temporal level values of the pictures that are indicated to be usable for inter-prediction (e.g., marked as “used for reference”) and that are identified in the reference picture window.

In one example of the implicit techniques, the video coder may determine that a reference picture (e.g., a picture currently identified in the window) is no longer usable for inter-prediction if the following two criteria are met. In this example, the video coder may determine whether (1) the temporal level value for the reference picture is equal to or greater than the temporal level value of the coded picture, which may be the first criteria. In addition, the video coder may determine whether (2) the coding order of the reference picture is earlier than a coding order of all reference pictures that have temporal level values that are equal to or greater than the temporal level value of the coded picture, which may be second criteria. For instance, the picture number value for the reference picture should be less than the picture number value of all reference pictures that have temporal level values that are equal to or greater than the temporal level value of the coded picture.

If reference picture meets both of these criteria, the video coder may determine that the reference picture is no longer usable for inter-prediction. In particular, if the reference picture has a temporal level value that is equal to or greater than the temporal level value of the coded picture, and the coding order of the reference picture is earlier than the coding order of all reference pictures that have temporal level values that are equal to or greater than the temporal level value of the coded picture, the video coder determines that the reference picture is no longer usable for inter-prediction of the coded picture. If there is no reference picture that meets both of these criteria, then the video coder may determine that all of the reference pictures that are currently indicated to be usable for inter-prediction should still be indicated to be usable for inter-prediction. The video coder may, in this example, determine that the coded picture, however, is not usable for inter-prediction. An illustrative example of this example of the implicit technique is described in more detail with respect to Table 1 below.

For example, as illustrated in more detail with respect to Table 1 below, the video coder may code a picture with reference to one or more reference pictures stored in the DPB. The video coder may determine a temporal level value of the coded picture. The video coder may also identify a set of reference pictures from the reference pictures stored in the DPB, each of which is currently indicated as usable for inter-prediction and has a temporal level value equal to or greater than the temporal level value of the coded picture. The video coder may further determine that a coding order of a reference picture in the set of reference pictures is earlier than a coding order of any other reference pictures in the set of reference pictures. The video coder may then determine that the reference picture is no longer usable for inter-prediction.

In another example of the implicit techniques, the video coder may determine that a reference picture (e.g., a picture currently identified in the reference picture window) is no longer usable for inter-prediction if the following three criteria are met. In this example, the video coder may determine whether (1) the temporal level value for the reference picture is equal to or greater than the temporal level value of the coded picture, which may be the first criteria. The video coder may determine whether (2) there are any reference pictures with a temporal level value greater than the temporal level value of the reference picture, which may be the second criteria. The video coder may further determine (3) whether the coding order of the reference picture is earlier than a coding order of all reference pictures that have temporal level values that are equal to the temporal level value of the reference picture.

If all three of these criteria are met, the video coder determines that the reference picture is no longer usable for inter-prediction. In other words, the video coder may determine that the reference picture is no longer useable for inter-prediction when the temporal level value for the reference picture is equal to or greater than the temporal level value of the coded picture, no other reference picture has a temporal level value greater than the temporal level value of the reference picture, and the coding order of the reference picture is earlier than a coding order of all reference pictures that have temporal level values that are equal to the temporal level value of the reference picture. In this example, the picture number value for the reference picture should be less than the picture number value of all reference pictures that have temporal level values that are equal to the temporal level value of the reference picture.

If there is no reference picture that meets all three of these criteria, then the video coder may determine that all of the reference pictures that are currently indicated to be usable for inter-prediction should still be indicated to be usable for inter-prediction. It may be possible for the video coder to determine that the coded picture should be usable for inter-prediction even when no current reference picture is determined to be unusable for inter-prediction. An illustrative example of this example of the implicit technique is described in more detail with respect to Table 1 below.

In the above two examples of the implicit technique, video encoder 20 and video decoder 30 may maintain a single reference picture window. For example, the window may include identifiers for all of the pictures that are usable for inter-prediction (e.g., identifiers for all of the reference pictures). In some examples, the temporal level values for the pictures identified in the window may be different from one another.

Some other techniques that utilize temporal level values to determine whether a picture should be used for inter-prediction rely on different sliding windows with different sizes that each correspond to a temporal level value, and require different criteria for each sliding window to determine whether a picture should be used for inter-prediction. Utilizing a single reference picture window, such as in the above two examples of this disclosure, may reduce management complexity. For example, video encoder 20 and video decoder 30 may manage a single reference picture window regardless of the temporal level values of the reference pictures, rather than multiple sliding windows for each of the temporal level values. Furthermore, the criteria for the two example techniques described above is applicable to the entirety of the single reference picture window. However, the other techniques may require different criteria to determine whether a picture is usable for inter-prediction, for each sliding window.

In other words, the two examples of the implicit technique may utilize a single reference picture window that is independent of the temporal level values in the determination of whether a reference picture should be indicated to be unusable for inter-prediction. For example, the temporal level value of one reference picture may be different than the temporal level value of another reference picture, and both of these reference pictures may be identified in the same, single reference picture window. For instance, the pictures marked as “used for reference” that are stored in the DPB may be part of the same reference picture window, and the temporal level values of these pictures may be different. Then, when the next picture is coded, video encoder 20 and video decoder 30 may compare the temporal level value for that coded picture against the temporal level values and the coding order of the pictures currently identified within the window, rather than only those reference pictures in a sliding window that corresponds to the temporal level value of the coded picture, as is the case in the other techniques.

In addition to utilizing a single reference picture window scheme, the implicit techniques may rely on both temporal level values and coding order as described above to determine whether a picture is usable for inter-prediction or unusable for inter-prediction. Relying on temporal level values may potentially result in video encoder 20 and video decoder 30 keeping reference pictures that are desirable for inter-prediction as usable for inter-prediction. For example, as described above, the temporal level values indicate which pictures can potentially be used for inter-prediction (e.g., pictures with temporal level values that are lower than or equal to a temporal level value of a current picture can be used to inter-predict the current picture). Accordingly, in some instances, it may be beneficial to keep pictures with lower temporal level values as reference pictures as such pictures can potentially be used for inter-predicting more pictures, as compared to pictures with higher temporal level values.

However, keeping only those pictures with low temporal level values as reference pictures may potentially not ensure optimal inter-prediction. For example, it may possibly be beneficial to utilize recently coded pictures as reference pictures for subsequent pictures so that video encoder 20 and video decoder 30 can limit the number of reference pictures that need to be stored in the DPB. For instance, if a picture with a relatively low temporal level value is displayed on display device 32, video decoder 30 may consider it beneficial to remove such a picture from the DPB to free storage space (i.e., make storage space available) in the DPB for subsequent pictures. Therefore, in one or more examples, the implicit techniques to determine whether a picture should be used for inter-prediction or not used for inter-prediction may rely on both temporal level values and coding order.

Some other techniques may rely on a single sliding window that uses coding order to determine whether a picture should be used for inter-prediction or not, but may not consider temporal level values. For instance, in these other techniques, pictures are removed from the sliding window in a first-in-first-out (FIFO) fashion. For example, when the sliding window is full, the picture that was included in the sliding window is removed first, and the current coded picture is included in the sliding window regardless of the temporal level values of the current picture, the picture removed from the sliding window, or any of the pictures within the sliding window. This FIFO-like technique may result in pictures being marked as “unused for reference” even when it may be desirable to keep such pictures for inter-prediction.

In another example technique, a video encoder signals syntax elements that specifically indicate which pictures should be marked as “used for reference” and which pictures should be marked as “unused for reference.” Such signaling consumes valuable transmission and reception bandwidth. Furthermore, such techniques require the video encoder to become more complex because the video encoder needs to decide which pictures should be used for inter-prediction. Making such determinations may be difficult for the video encoder, and especially when the size of a group of pictures (GOP) is adaptive.

As discussed above, the techniques of this disclosure provide for examples of implicit techniques that video encoder 20 and video decoder 30 may implement. Because the techniques are implicit, video encoder 20 and video decoder 30 may be preprogrammed or otherwise configured to, or made operable to, perform the implicit techniques without needing to transmit or receive information that indicates the manner in which video encoder 20 and video decoder 30 should determine which pictures are usable for inter-prediction and which ones are not. In other words, the techniques described in the disclosure may not require transmission or reception of information that defines the specific steps or functions that video encoder 20 and video decoder 30 need to perform to determine which pictures are usable for inter-prediction and which ones are not. Also, the techniques described in this disclosure may not require transmission and reception of information that identifies specific pictures that are usable for inter-prediction or unusable for inter-prediction.

In some examples, the implicit techniques may include an initialization stage whereby video encoder 20 and video decoder 30 initially indicate which pictures are usable for inter-prediction (e.g., which pictures are reference pictures). For instance, there may be threshold number of pictures (M) that can be used for inter-prediction. Video encoder 20 may signal the value of M in the active sequence parameter set (SPS), picture parameter set (PPS), slice header, picture header, or at any syntax level.

As video encoder 20 and video decoder 30 code pictures, video encoder 20 and video decoder 30 may indicate that each of these coded pictures is usable for inter-prediction (e.g., each picture is a reference picture) until the total number of pictures indicated to be reference pictures equals M. Then, for the next picture, video encoder 20 and video decoder 30 may implement the example implicit techniques described above to determine whether a current reference picture is no longer usable for inter-prediction.

As an example, assume the value of M equals 5. In this example, for the first five coded pictures (e.g., pictures with picture number value 0 through 4) in a group of pictures (GOP), video encoder 20 and video decoder 30 may determine that each of these pictures is a reference picture. Then, for the next coded picture (e.g., the picture with picture number value 5), video encoder 20 and video decoder 30 may determine whether any one of the reference pictures with picture number value 0 through 4 is no longer usable for inter-prediction based on temporal level values and coding order. In this way, the occurrence of the total number of reference pictures being equal to or greater than the value of M may trigger video encoder 20 and video decoder 30 to implement the implicit techniques discussed above.

In some examples, the implicit techniques described in this disclosure may be directed to short-term reference pictures. Short-term reference pictures refer to pictures that are needed as reference pictures for a relatively short period of time. Generally, although not always, short-term reference pictures are used for inter-predicting temporally proximate pictures, in coding order. Long-term reference pictures refer to pictures that are needed as reference pictures for a relatively large period of time. In some instances, long-term reference pictures may be used for inter-predicting temporally distance pictures, in coding order.

As one example, the pictures identified in the reference picture window may each be short-term reference pictures, and the window may not identify any long-term reference pictures. In this example, when video encoder 20 or video decoder 30 code a picture identified to be a long-term reference picture, the implicit techniques may bypass such a picture (e.g., may make no determination as to whether this long-term reference picture is usable or unusable for inter-prediction). In general, the techniques of this disclosure may function as described above regardless of the manner in which video encoder 20 and video decoder 30 manage long-term reference pictures; however, aspects of this disclosure are not so limited.

Some further techniques may provide refinements to the example implicit techniques described above. For instance, video encoder 20 may signal a flag that video decoder 30 receives. This flag may be for pictures with temporal level value of 0, and video encoder 20 may signal the flag in the slice header of the picture. When video decoder 30 decodes this flag to be true (e.g., when the flag value is “1”), video decoder 30 may determine that all previous short-term pictures are unusable for inter-prediction except the short-term picture with a temporal level value of 0 that is closest to the current picture in coding order. In other words, when the flag is true, video decoder 30 may mark each picture identified in the reference picture window as “unused for reference” except for the picture with a temporal level value of 0 that was latest coded picture among the pictures with temporal level values of 0.

It should be understood that the flag described above is not a syntax element that defines the manner in which video encoder 20 and video decoder 30 determine whether a picture is usable or unusable for inter-prediction. Rather, the flag described above indicates to video decoder 30 that video decoder 30 should implement the technique of determining that pictures in the reference picture window are unusable for inter-prediction expect for the reference picture with a temporal level value of 0 that was coded the last among the pictures with temporal level values of 0. The above described flag is not necessary in every example of the implicit techniques, and the implicit techniques may be functional without the inclusion of the above described example flag.

As another refinement, the implicit techniques may be capable of functioning even when a picture is lost. For example, due to some transmission error such as in communication channel 16, storage medium 17, and server 19, a picture signaled by video encoder 20 may not be received by video decoder 30. In this case, video decoder 30 may not be able to determine the temporal level value for this lost picture, but may be able to determine the coding order for this lost picture. For example, when a picture is lost, there may be a gap in the consecutive order of the picture number values. As an illustrative value, if video decoder 30 receives a picture with picture number value of 5 and then receives a picture with a picture number value of 7, there is a gap in the picture number values. In this example, due to the gap in the picture number values, video decoder 30 may determine that one picture is lost, and its picture number value is 6.

Even in examples where a picture is lost, video decoder 30 may still utilize the implicit techniques described in this disclosure. In a situation where video decoder 30 determines that one or more pictures are lost, video decoder 30 may assign the highest possible temporal level value to these lost pictures. Video decoder 30 may then utilize the implicit techniques described above with the temporal level values for the lost pictures being the highest possible temporal level value.

As described above, the JCT-VC is working on development of the HEVC standard. The following is a more detailed description of the HEVC standard to assist with understanding. However, as indicated above, the techniques of this disclosure are not limited to the HEVC standard, and may be applicable to other video coding standards and video coding in general. For example, the implicit techniques may be applied to video coding that generally conforms to the H.264/AVC standard, but is adapted to make use of the techniques described in this disclosure.

The HEVC standardization efforts are based on a model of a video coding device referred to as the HEVC Test Model (HM). The HM presumes several additional capabilities of video coding devices relative to existing devices according to, e.g., ITU-T H.264/AVC. For example, whereas H.264 provides nine intra-prediction encoding modes, the HM provides as many as thirty-three intra-prediction encoding modes.

The HM refers to a block of video data as a coding unit (CU). Syntax data within a bitstream may define a largest coding unit (LCU), which is a largest coding unit in terms of the number of pixels. In general, a CU has a similar purpose to a macroblock of the H.264 standard, except that a CU does not have a size distinction. Thus, a CU may be split into sub-CUs. In general, references in this disclosure to a CU may refer to a largest coding unit (LCU) of a picture or a sub-CU of an LCU. An LCU may be split into sub-CUs, and each sub-CU may be further split into sub-CUs. Syntax data for a bitstream may define a maximum number of times an LCU may be split, referred to as CU depth. Accordingly, a bitstream may also define a smallest coding unit (SCU).

A CU that is not further split may include one or more prediction units (PUs). In general, a PU represents all or a portion of the corresponding CU, and includes data for retrieving a reference sample for the PU. For example, when the PU is intra-mode encoded, i.e., intra-predicted, the PU may include data describing an intra-prediction mode for the PU. As another example, when the PU is inter-mode encoded, i.e., inter-predicted, the PU may include data defining a motion vector for the PU.

The data defining the motion vector for a PU may describe, for example, a horizontal component of the motion vector, a vertical component of the motion vector, a resolution for the motion vector (e.g., one-quarter pixel precision or one-eighth pixel precision), a reference picture to which the motion vector points, and/or a reference picture list for the motion vector. Data for the CU defining the PU(s) may also describe, for example, partitioning of the CU into one or more PUs. Partitioning modes may differ between whether the CU is skip or direct mode encoded, intra-prediction mode encoded, or inter-prediction mode encoded.

A CU having one or more PUs may also include one or more transform units (TUs). Following prediction using a PU, video encoder 20 may calculate residual values for the portion of the CU corresponding to the PU. The residual values correspond to pixel difference values that may be transformed into transform coefficients quantized, and scanned to produce serialized transform coefficients for entropy coding. A TU is not necessarily limited to the size of a PU. Thus, TUs may be larger or smaller than corresponding PUs for the same CU. In some examples, the maximum size of a TU may be the size of the corresponding CU. This disclosure uses the term “video block” to refer to any of a CU, PU, or TU.

A video sequence typically includes a series of video pictures. A group of pictures (GOP) generally comprises a series of one or more video pictures. A GOP may include syntax data in a header of the GOP, a header of one or more pictures of the GOP, or elsewhere, that describes a number of pictures included in the GOP. Each picture may include picture syntax data that describes an encoding mode for the respective picture. Video encoder 20 typically operates on video blocks within individual video pictures in order to encode the video data. A video block may correspond to a coding unit (CU) or a partition unit (PU) of the CU. The video blocks may have fixed or varying sizes, and may differ in size according to a specified coding standard. Each video picture may include a plurality of slices. Each slice may include a plurality of CUs, which may include one or more PUs.

As an example, the HEVC Test Model (HM) supports prediction in various CU sizes. The size of an LCU may be defined by syntax information. Assuming that the size of a particular CU is 2N×2N, the HM supports intra-prediction in sizes of 2N×2N or N×N, and inter-prediction in symmetric sizes of 2N×2N, 2N×N, N×2N, or N×N. The HM also supports asymmetric splitting for inter-prediction of 2N×nU, 2N×nD, nL×2N, and nR×2N. In asymmetric splitting, one direction of a CU is not split, while the other direction is split into 25% and 75%. The portion of the CU corresponding to the 25% split is indicated by an “n” followed by an indication of “Up”, “Down,” “Left,” or “Right.” Thus, for example, “2N×nU” refers to a 2N×2N CU that is split horizontally with a 2N×0.5N PU on top and a 2N×1.5N PU on bottom.

In this disclosure, “N×N” and “N by N” may be used interchangeably to refer to the pixel dimensions of a video block (e.g., CU, PU, or TU) in terms of vertical and horizontal dimensions, e.g., 16×16 pixels or 16 by 16 pixels. In general, a 16×16 block will have 16 pixels in a vertical direction (y=16) and 16 pixels in a horizontal direction (x=16). Likewise, an N×N block generally has N pixels in a vertical direction and N pixels in a horizontal direction, where N represents a nonnegative integer value. The pixels in a block may be arranged in rows and columns. Moreover, blocks need not necessarily have the same number of pixels in the horizontal direction as in the vertical direction. For example, blocks may comprise N×M pixels, where M is not necessarily equal to N.

Following intra-predictive or inter-predictive coding to produce a PU for a CU, video encoder 20 may calculate residual data to produce one or more transform units (TUs) for the CU. PUs of a CU may comprise pixel data in the spatial domain (also referred to as the pixel domain), while TUs of the CU may comprise coefficients in the transform domain, e.g., following application of a transform such as a discrete cosine transform (DCT), an integer transform, a wavelet transform, or a conceptually similar transform to residual video data. The residual data may correspond to pixel differences between pixels of the unencoded picture and prediction values of a PU of a CU. Video encoder 20 may form one or more TUs including the residual data for the CU. Video encoder 20 may then transform the TUs to produce transform coefficients.

Following any transforms to produce transform coefficients, quantization of transform coefficients may be performed. Quantization generally refers to a process in which transform coefficients are quantized to possibly reduce the amount of data used to represent the coefficients, providing further compression. The quantization process may reduce the bit depth associated with some or all of the coefficients. For example, an n-bit value may be rounded down to an m-bit value during quantization, where n is greater than m.

In some examples, video encoder 20 may utilize a predefined scan order to scan the quantized transform coefficients to produce a serialized vector that can be entropy encoded. In other examples, video encoder 20 may perform an adaptive scan. After scanning the quantized transform coefficients to form a one-dimensional vector, video encoder 20 may entropy encode the one-dimensional vector, e.g., according to context adaptive variable length coding (CAVLC), context adaptive binary arithmetic coding (CABAC), syntax-based context-adaptive binary arithmetic coding (SBAC), or another entropy encoding methodology.

To perform CABAC, video encoder 20 may select a context model to apply to a certain context to encode symbols to be transmitted. The context may relate to, for example, whether neighboring values are non-zero or not. To perform CAVLC, video encoder 20 may select a variable length code for a symbol to be transmitted. Codewords in VLC may be constructed such that relatively shorter codes correspond to more probable symbols, while longer codes correspond to less probable symbols. In this way, the use of VLC may achieve a bit savings over, for example, using equal-length codewords for each symbol to be transmitted. The probability determination may be based on the context assigned to the symbols.

Video decoder 30 may operate in a manner essentially symmetrical to that of video encoder 20. For example, video decoder 30 may entropy decode the received video bitstream, and decode a picture in a symmetric manner as the manner in which video encoder 20 encoded the picture. For instance, video encoder 20 may encode a picture with reference to one or more reference pictures identified in the reference picture window. Video decoder 30 may decode the picture with reference to the same one or more reference pictures. Utilizing the implicit techniques described in this disclosure may ensure that the pictures identified in the reference picture window at the video encoder 20 side are the same pictures identified in the reference picture window at the video decoder 30 side.

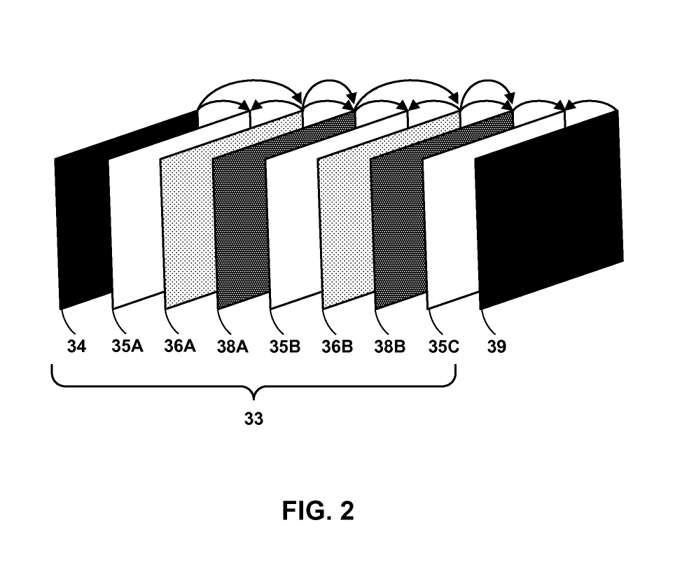

FIG. 2 is a conceptual diagram illustrating an example video sequence 33 that includes pictures 34, 35A, 36A, 38A, 35B, 36B, 38B, and 35C, in display order. In some cases, video sequence 33 may be referred to as a group of pictures (GOP). Picture 39 is a first picture in display order for a sequence occurring after sequence 33. FIG. 2 generally represents an exemplary prediction structure for a video sequence and is intended only to illustrate the picture references used for encoding different inter-predicted pictures. For example, the illustrated arrows point to the picture that is used as a reference picture to inter-predict the picture from which the arrows emanate. An actual video sequence may contain more or fewer video pictures in a different display order.

In FIG. 2, GOP 33 may include a key picture, and all pictures which are located in the output/display order between this key picture and the next key picture. For example, picture 34 and picture 39 may each be a key picture. In this example, GOP 33 includes picture 34 and all pictures until picture 39. A key picture, such as picture 34 and picture 39, may be a picture that is not coded with reference to any other picture (e.g., an intra-predicted picture); however, aspects of this disclosure are not so limited.

For block-based video coding, each of the video pictures included in sequence 33 may be partitioned into video blocks or coding units (CUs). Each CU of a video picture may include one or more prediction units (PUs). Video blocks or PUs in an intra-predicted picture are encoded using spatial prediction with respect to neighboring blocks in the same picture. Video blocks or PUs in an inter-predicted picture may use spatial prediction with respect to neighboring blocks in the same picture or temporal prediction with respect to other reference pictures.

Some video blocks may be encoded using bi-predictive coding to calculate two motion vectors from two reference pictures. Some video blocks may be encoded using uni-directional predictive coding from one reference picture identified. In accordance with one or more examples described in this disclosure, each one of these pictures (e.g., picture 34, pictures 35A-35C, and picture 39) may be reference pictures that can be used for inter-prediction. Each one of these pictures may be associated with a temporal level value that defines for which pictures that picture can be a reference picture. For example, in FIG. 2, at least one block within picture 36A is inter-predicted from a block within picture 34. In this example, the temporal level value of picture 34 is at least equal to or less than the temporal level value of picture 36A. In some examples, the temporal level value for each of the key pictures may be 0; however, aspects are not so limited.

In the example of FIG. 2, first picture 34 is designated for intra-prediction as an I picture. In other examples, first picture 34 may be coded with inter-prediction. Video pictures 35A-35C (collectively “video pictures 35”) are inter-predicted and designated for coding as B-pictures using bi-prediction with reference to a past picture and a future picture. In the illustrated example, picture 35A is encoded as a B-picture with reference to first picture 34 and picture 36A, as indicated by the arrows from picture 34 and picture 36A to video picture 35A. Pictures 35B and 35C are similarly encoded.

Video pictures 36A-36B (collectively “video pictures 36”) are inter-predicted and may be designated for coding as P-pictures or B-pictures using uni-direction prediction with reference to a past picture. In the illustrated example, picture 36A is encoded as a P-picture or a B-picture with reference to first picture 34, as indicated by the arrow from picture 34 to video picture 36A. Picture 36B is similarly encoded as a P-picture or B-picture with reference to picture 38A, as indicated by the arrow from picture 38A to video picture 36B.

Video pictures 38A-38B (collectively “video pictures 38”) are inter-predicted and may be designated for coding as P-pictures or B-pictures using uni-directional prediction with reference to the same past picture. In the illustrated example, picture 38A is encoded with two references to picture 36A, as indicated by the two arrows from picture 36A to video picture 38A. Picture 38B is similarly encoded with respect to picture 36B.

In accordance with the techniques of this disclosure, video encoder 20 and video decoder 30 may manage their respective decoded picture buffers (DPBs) to determine which pictures of the pictures illustrated in FIG. 2 should be marked as “used for reference” and which ones should not be marked as “used for reference.” For example, as video encoder 20 and video decoder 30 code the pictures illustrated in FIG. 2, video encoder 20 and video decoder 30 may determine whether any picture currently indicated to be used for inter-prediction should no longer be indicated to be used for inter-prediction utilizing one or more of the example techniques described in this disclosure.

For instance, an illustrative example with hypothetical values is provided below with respect to Table 1. These hypothetical values are used to illustrate the techniques of the example implicit techniques described above. In Table 1, the GOP size of pictures is 16. The first row of Table 1 includes the coding order of the pictures, and may be represented by the picture number values of the pictures. The second row of Table 1 includes the display order of the picture, and may be represented by the picture order count (POC) values. As can be seen in Table 1, the coding order of the pictures and the display order of the pictures may different. The third row in Table 1 includes the temporal level values for the pictures.

TABLE 1

| | Pic num value | | | | | | | | | | | | | | | |
|---|---|---|---|---|---|---|---|---|---|---|---|---|---|---|---|---|
| | 0 | 1 | 2 | 3 | 4 | 5 | 6 | 7 | 8 | 9 | 10 | 11 | 12 | 13 | 14 | 15 |
| Pic | 0 | 16 | 8 | 4 | 2 | [symbol] | [symbol] | 6 | [symbol] | [symbol] | 12 | 10 | [symbol] | [symbol] | 14 | [symbol] |
| order | | | | | | | | | | | | | | | | |
| count | | | | | | | | | | | | | | | | |
| (POC) | | | | | | | | | | | | | | | | |
| value | | | | | | | | | | | | | | | | |
| Temp | 0 | 0 | 0 | 1 | 2 | 3 | 3 | 2 | 3 | 3 | 1 | 2 | 3 | 3 | 2 | 3 |
| level | | | | | | | | | | | | | | | | |
| value | | | | | | | | | | | | | | | | |

Furthermore, assume that the threshold number of pictures (M) that can be used for inter-prediction is 5. Also, assume that the pictures with the POC value of 1, 3, 5, 7, 9, 11, and 13 are long-term reference pictures, which are bolded, underlined, and italicized in Table 1 for clarity. The long-term reference pictures may be long-term reference pictures based on various criteria selected by video encoder 20. In general, the techniques of this disclosure may function in a substantially similar manner regardless of the criteria used to determine which pictures are long-term reference pictures, or the number of pictures that are determined to be long-term reference pictures; however, aspects of this disclosure should not be considered so limited. These assumptions and hypothetical vales are applicable for both of the following examples.

In examples of the implicit technique, video encoder 20 and video decoder 30 may first fill the reference picture window with identifiers for the picture until the total number of pictures in the window equal the threshold value M, which is 5 in this example. Also, the identifiers used to designate the pictures in the reference picture window may be the POC values. Accordingly, in this example, after coding the picture with POC value 0, which is the first picture in coding order in the example of Table 1 because its picture number value is also 0, the identifiers in the reference picture window may be {0}. After coding the picture with POC value 16, which is the next picture in coding order because its picture number value is 1 in the example of Table 1, the identifiers in the reference picture window may be {0, 16}. This process may continue until the picture with the POC value of 2 (e.g., until the number of pictures identified to be reference pictures equals M), and the identifiers in the reference picture window may be {0, 16, 8, 4, 2}. So far, pictures with POC values 0, 16, 8, 4, and 2 are reference pictures (e.g., indicated to be usable for reference) and may be marked as “used for reference” in the DPBs of video encoder 20 and video decoder 30.

At this juncture, the number of pictures identified in the reference picture window equals the threshold value M, which may trigger the examples of the implicit technique. However, in this example, the next two pictures (e.g., pictures with POC values 1 and 3) are both long-term pictures; so, the implicit technique bypasses these two pictures and moves to the picture with POC value 6. Video encoder 20 and video decoder 30 may then code the picture with POC value 6, and may determine whether any of the reference pictures in the DPB (e.g., identified in the reference picture window) should become unusable for inter-prediction, or whether the picture with POC value 6 should be unusable for inter-prediction.

In the first example of the implicit technique, video encoder 20 or video decoder 30 may determine that a reference picture, that is currently indicated as being usable for inter-prediction, is no longer usable for inter-prediction when the following two criteria are true for the reference picture. For example, video encoder 20 and video decoder 30 may determine whether it is true that the temporal level value of the reference picture is equal to or greater than the temporal level value of the coded picture. Video encoder 20 and video decoder 30 may also determine whether it is true that the coding order for the reference picture is earlier than a coding order of all reference pictures that have temporal level values that are equal to or greater than the temporal level value of the coded picture.

For example, video encoder 20 and video decoder 30 identify a set of reference pictures from the reference pictures stored in the DPB, each of which is currently indicated as usable for inter-prediction and has a temporal level value equal to or greater than the temporal level value of the coded picture. Video encoder 20 and video decoder 30 may determine that a coding order of a reference picture in the set of reference pictures is earlier than a coding order of any other reference pictures in the set of reference pictures.

If a reference picture satisfies both of these criteria, then in the first example of the implicit technique, video encoder 20 and video decoder 30 may determine that the reference picture is now unusable for inter-prediction, and may determine that the coded picture is usable for inter-prediction. Otherwise, video encoder 20 and video decoder 30 may determine that the coded picture is no longer usable for inter-prediction.

For instance, after the picture with POC value 6 is coded, video encoder 20 and video decoder 30 may determine that the temporal level value of the picture with POC value 6 is 2. In this case, of the pictures in the reference picture window (e.g., reference pictures that are usable of inter-prediction), only the picture with POC value 2 satisfies the first criteria (e.g., its temporal level value is equal to or greater than the temporal level value of the picture with POC value 6). In this case, video encoder 20 and video decoder 30 may identify only the picture with POC value 2 as the set of reference pictures with temporal level value equal to or greater than the temporal level value of the picture with POC value 6. Also, the picture with POC value 2 satisfies the second criteria (i.e., the coding order of the picture with POC value 2 is earlier than the coding order of any picture with temporal level value greater than or equal to the temporal level value of 2). For example, the picture number value of the picture with POC value 2 is less than the picture number value of any picture with temporal level value greater than or equal to the temporal level value of 2. In this case, in accordance with the first example of the implicit technique, video encoder 20 and video decoder 30 may remove the picture with POC value 2 from the reference picture window, and insert the picture with POC value 6 instead. Accordingly, the reference picture window may now be {0, 16, 8, 4, 6}.

The next two pictures (e.g., pictures with POC values 5 and 7) are both long-term reference pictures. Therefore, in this example, the implicit techniques may bypass these two pictures in terms of determining whether there is any change to the pictures identified in the reference picture window, and move to the picture with POC value 12.

After the picture with POC value 12 is coded, video encoder 20 and video decoder 30 may determine that the temporal level value of the picture with POC value 12 is 1. In this case, of the pictures in the reference picture window (e.g., reference pictures that are usable of inter-prediction), the pictures with POC values 4 and 6 satisfy the first criteria (i.e., the temporal level values for the pictures with POC values 4 and 6 are equal to or greater than the temporal level value of the picture with POC value 12). In this example, video encoder 20 and video decoder 30 may identify the pictures with POC values 4 and 6 as belonging to a set of reference pictures that each are currently indicated as usable for inter-prediction and has a temporal level value equal to or greater than the temporal level value of the picture with POC value 12. However, only the picture with POC value 4 satisfies the second criteria (e.g., the coding order of the picture with POC value 4 is earlier than the coding order of any picture with temporal level value greater than or equal to the temporal level value of the picture with POC value 12). In other words, the picture number value of the picture with POC value 4 is less than the picture number value of any of the pictures with the temporal level value greater than or equal to the temporal level value of the picture with POC value 12 (e.g., the picture number value of the picture with POC value 4 is less than the picture number value of the picture with POC value 6).

Therefore, only the picture with POC value 4 satisfies both the first and second criteria of the first example of the implicit technique. In this case, in accordance with the first example of the implicit technique, video encoder 20 and video decoder 30 may remove the picture with POC value 4 from the reference picture window, and insert the picture with POC value 12 instead because the picture with the POC value of 12 is the just coded picture. Accordingly, the reference picture window may now be {0, 16, 8, 6, 12}, and video encoder 20 and video decoder 30 may proceed with the next picture (e.g., the picture with POC value 10).

After the picture with POC value 10 is coded, video encoder 20 and video decoder 30 may determine that the temporal level value of the picture with POC value 10 is 2. In this case, of the pictures in the reference picture window (e.g., reference pictures that are usable of inter-prediction), only the picture with POC value 6 satisfies the first criteria (e.g., its temporal level value is equal to or greater than the temporal level value of the picture with POC value 10). In this case, the picture with POC value 6 may be the only picture in the identified set of reference pictures. Also, the picture with POC value 6 satisfies the second criteria (e.g., the coding order based on the picture number value of the picture with POC value 6 is earlier than the coding order of any picture with temporal level value greater than or equal to the temporal level value of 2). In this case, in accordance with the first example of the implicit technique, video encoder 20 and video decoder 30 may remove the picture with POC value 6 from the reference picture window, and insert the picture with POC value 10 instead. Accordingly, the reference picture window may now be {0, 16, 8, 12, 10}.

The next two pictures (e.g., the pictures with POC values 9 and 11) are both long-term reference pictures. Therefore, in this example, the implicit techniques may bypass these two pictures (the pictures with POC values 9 and 11) in terms of determining whether there is any change to the pictures identified in the reference picture window, and move to the picture with POC value 14.

After the picture with POC value 14 is coded, video encoder 20 and video decoder 30 may determine that the temporal level value of the picture with POC value 14 is 2. In this case, of the pictures in the reference picture window (e.g., reference pictures that are usable of inter-prediction), only the picture with POC value 10 satisfies the first criteria (e.g., its temporal level value is equal to or greater than the temporal level value of the picture with POC value 14). In this case, the picture with POC value 10 may be the only picture in the identified set of reference pictures. Also, the picture with POC value 10 satisfies the second criteria (e.g., the coding order of the picture with POC value 10 is earlier than the coding order of any picture with temporal level value greater than or equal to the temporal level value of 2). In this case, in accordance with the first example of the implicit technique, video encoder 20 and video decoder 30 may remove the picture with POC value 10 from the reference picture window, and insert the picture with POC value 14 instead. Accordingly, the reference picture window may now be {0, 16, 8, 12, 10}.

In this case, the picture with POC value 13 is a long-term reference picture. Therefore, in this example, the implicit techniques may bypass the picture with POC value 13 in terms of determining whether there is any change to the pictures identified in the reference picture window. In this way, the above illustrates an example of the manner in which video encoder 20 and video decoder 30 may implement the first example of the implicit techniques. For example, no signaling of syntax elements may be needed for video encoder 20 and video decoder 30 to implement the first example. Furthermore, the techniques may be based on a combination of temporal level values and coding order.

The following illustrates the second example of the implicit technique in greater detail based on the hypothetical values of Table 1 and the assumptions described above. For instance, similar to the first example, in the second example, the reference picture window may initially be {0, 16, 8, 4, 2} so that the total number of pictures identified in the reference picture window equals M (i.e., 5). Also, similar to above, because the pictures with POC values 1 and 3 are long-term reference pictures, the second example of the implicit technique bypasses these pictures (the pictures with POC values 1 and 3) in terms of determining whether there is any change to the pictures identified in the reference picture window. The second example of the implicit technique may begin with the picture with POC value 6.

In the second example of the implicit technique, video encoder 20 or video decoder 30 may determine that a reference picture, that is currently indicated as being usable for inter-prediction, is no longer usable for inter-prediction when the following three criteria are true for the reference picture. For example, video encoder 20 and video decoder 30 may determine whether it is true that a temporal level value of the reference picture is equal to or greater than the temporal level value of the coded picture. Video encoder 20 and video decoder 30 may determine whether it is true that no other reference picture has a temporal level value greater than the temporal level value of the reference picture. Video encoder 20 and video decoder 20 may determine whether it is true that a coding order for the reference picture is earlier than a coding order of all reference pictures that have temporal level values that are equal to the temporal level value of the reference picture.

If a reference picture satisfies all three of these criteria, then in the second example of the implicit technique, video encoder 20 and video decoder 30 may determine that the reference picture is now unusable for inter-prediction, and may determine that the coded picture is usable for inter-prediction. Otherwise, video encoder 20 and video decoder 30 may determine that the coded picture is usable for inter-prediction.

For example, after the picture with POC value 6 is coded, video encoder 20 and video decoder 30 may determine that the temporal level value of the picture with POC value 6 is 2. In this case, only the picture with POC value 2 satisfies the first criteria because the picture with POC value 2 is the only picture whose temporal level value is equal to or greater than the temporal level value of the picture with POC value 6. Also, the picture with POC value 2 satisfies the second criteria because there is no other reference picture with a greater temporal level value than the picture with POC value 2. Moreover, the picture with POC value 2 satisfies the third criteria because the coding order of the picture with POC value 2 is earlier than the coding order of all reference pictures that have temporal level values that are equal to the temporal level value of the picture with POC value 2. Accordingly, in this example, video encoder 20 and video decoder 30 may remove the picture with POC value 2 from the reference picture window, and insert the picture with POC value 6 instead. The reference picture window may now be {0, 16, 8, 4, 6}.

As before, the next two pictures (e.g., the pictures with POC values 5 and 7) are both long-term reference pictures. Therefore, in this example, the implicit techniques may bypass these two pictures (the pictures with POC values 5 and 7) in terms of determining whether there is any change to the pictures identified in the reference picture window, and move to the picture with POC value 12.

After the picture with POC value 12 is coded, video encoder 20 and video decoder 30 may determine that the temporal level value of the picture with POC value 12 is 1. The pictures with POC values 4 and 6 may satisfy the first criteria because their respective temporal level values are greater than or equal to the temporal level value of the picture with POC value 12. Between the pictures with POC values 4 and 6, the picture with POC value 6 satisfies the second criteria because the temporal level value of the picture with POC value 6 is greater than that of the picture with POC value 4. The picture with POC value 6 also satisfies the third criteria because the coding order of the picture with POC value 6 is earlier than the coding order of all reference pictures that have temporal level values that are equal to the temporal level value of the picture with POC value 6. Accordingly, in this example, video encoder 20 and video decoder 30 may remove the picture with POC value 6 from the reference picture window, and insert the picture with POC value 12 instead. The reference picture window may now be {0, 16, 8, 4, 12}, and the technique may move to the picture with POC value 10.

After the picture with POC value 10 is coded, video encoder 20 and video decoder 30 may determine that the temporal level value of the picture with POC value 10 is 2. In this situation, there is no reference picture that satisfies the first criteria. For example, the temporal level values for the pictures with POC values 0, 16, 8, 4, and 12 are each less than the temporal level value of the picture with POC value 10. Accordingly, an analysis of the second and third criteria may not be needed as no picture meets the first criteria. In this example, the second example of the implicit technique may not remove any pictures from the reference picture window, and may instead include the picture with POC value 10 in the reference picture window. The reference picture window may now be {0, 16, 8, 4, 12, 10}.

The next two pictures (e.g., the pictures with POC values 9 and 11) are both long-term reference pictures. Therefore, in this example, the implicit techniques may bypass these two pictures (the pictures with POC values 9 and 11) in terms of determining whether there is any change to the pictures identified in the reference picture window, and move to the picture with POC value 14.

After the picture with POC value 14 is coded, video encoder 20 and video decoder 30 may determine that the temporal level value of the picture with POC value 14 is 2. In this situation, the picture with POC value 10 is the only picture that satisfies the first criteria because the temporal level value for no other picture is equal to or greater than the temporal level value of the picture with POC value 14. The picture with POC value 10 may also satisfy the second criteria because no other reference picture has a temporal level value greater than the temporal level value of the picture with POC value 10. Moreover, the picture with POC value 10 may also satisfy the third criteria because the coding order of the picture with POC value 10 is earlier than the coding order of all reference pictures that have temporal level values that are equal to the temporal level value of the picture with POC value 10. Accordingly, in this example, the second example of the implicit technique may remove the picture with POC value 10, and insert the picture with POC value 14 instead. The resulting reference picture window may be {0, 16, 8, 4, 12, 14}.

As above, the picture with POC value 13 is a long-term reference picture. Therefore, in this example, the implicit techniques may bypass the picture with POC value 13 in terms of determining whether there is any change to the pictures identified in the reference picture window. In this way, the above illustrates an example of the manner in which video encoder 20 and video decoder 30 may implement the second example of the implicit techniques. For example, as before, no signaling of syntax elements may be needed for video encoder 20 and video decoder 30 to implement the first example. Furthermore, the techniques may be based on a combination of temporal level values and coding order.

Also, as can be seen above, in the first example of the implicit technique, the number of pictures in the reference picture window may never be greater than the threshold number of pictures (M), as a non-limiting condition. In some instances, the threshold number of pictures (M) may define the maximum number of pictures that can be used for inter-prediction (e.g., the maximum number of pictures within the reference picture window), in addition to the number of pictures needed before the start of the determination of whether a reference picture should be indicated as no longer being usable for inter-prediction based on coding order and temporal level values.

In the second example of the implicit techniques, the number of pictures in the reference picture window may possibly be greater than the threshold number of pictures (M), as a non-limiting condition. In this case, the threshold number of pictures (M) may define the number of pictures needed before the start of the determination of whether a reference picture should be indicated as no longer being usable for inter-prediction based on coding order and temporal level values.

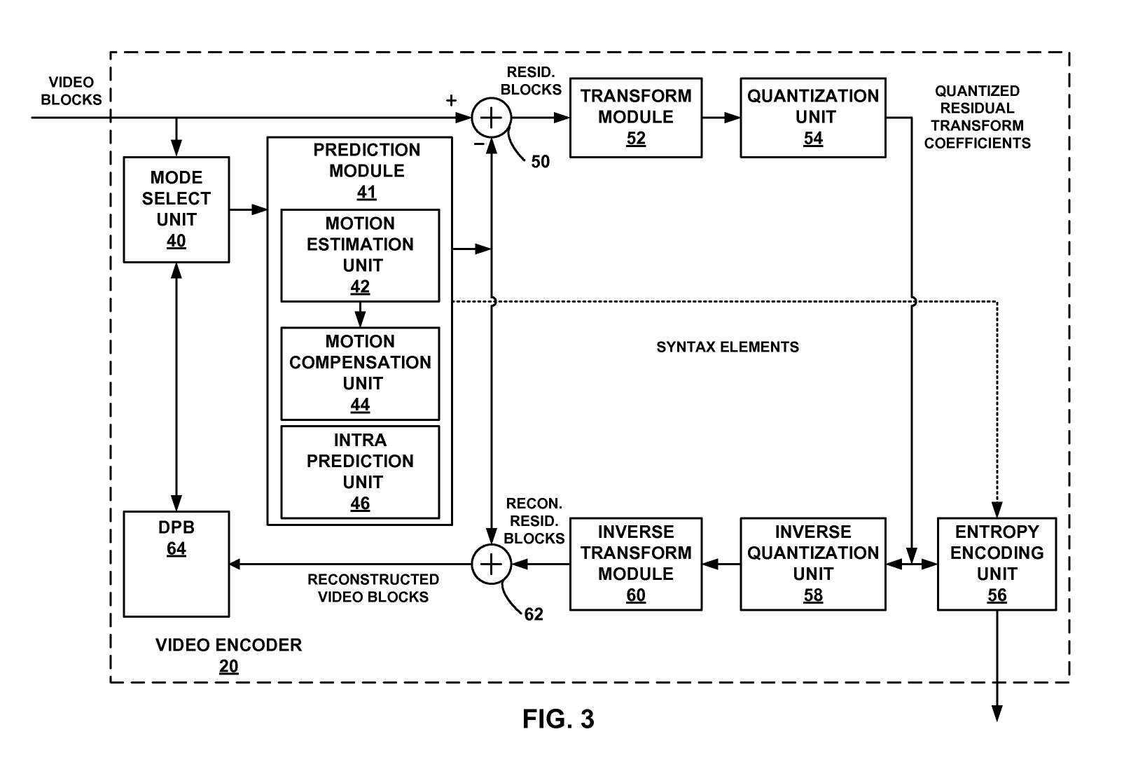

FIG. 3 is a block diagram illustrating an example of video encoder 20 that may implement techniques in accordance with one or more aspects of this disclosure. Video encoder 20 may perform intra- and inter-coding of video blocks within video pictures. Intra-coding relies on spatial prediction to reduce or remove spatial redundancy in video within a given video picture. Inter-coding relies on temporal prediction to reduce or remove temporal redundancy in video within adjacent pictures of a video sequence. Intra-mode (I mode) may refer to any of several spatial based compression modes. Inter-modes such as unidirectional prediction (P mode) and bi-prediction (B mode) may refer to any of several temporal-based compression modes.

In the example of FIG. 3, video encoder 20 includes mode select unit 40, prediction module 41, decoded picture buffer (DPB) 64, summer 50, transform module 52, quantization unit 54, and entropy encoding unit 56. Prediction module 41 includes motion estimation unit 42, motion compensation unit 44, and intra prediction unit 46. For video block reconstruction, video encoder 20 also includes inverse quantization unit 58, inverse transform module 60, and summer 62. A deblocking filter (not shown in FIG. 3) may also be included to filter block boundaries to remove blockiness artifacts from reconstructed video. If desired, the deblocking filter would typically filter the output of summer 62.

As shown in FIG. 3, video encoder 20 receives a current video block within a video picture or slice to be encoded. The picture or slice may be divided into multiple video blocks or CUs, as one example, but include PUs and TUs as well. Mode select unit 40 may select one of the coding modes, intra or inter, for the current video block based on error results, and prediction module 41 may provide the resulting intra- or inter-coded block to summer 50 to generate residual block data and to summer 62 to reconstruct the encoded block for use as a reference picture.

In some examples, mode select unit 40 may be implement the example techniques described above. For example, mode select unit 40 may be configured to manage DPB 64. As a few examples, the management of DPB 64 by mode select unit 40 may include a storage process in which the reconstructed picture (referred to as a decoded picture) from summer 62 is stored in DPB 64, a marking process of the stored pictures (e.g., marking a picture as “used for reference” or “unused for reference”), and output and removal processes of the decoding pictures in DPB 64. The removal process may refer to removing the picture from DPB 64 after the picture is signaled, as one example.

For example, mode select unit 40 may implement at least one of the examples of the implicit technique described above to determine whether a reference picture stored in DPB 64, currently indicated to be usable for inter-prediction, is no longer usable for inter-prediction. Mode select unit 40 may maintain the reference picture window, as described in this disclosure, and remove and insert pictures into the reference picture window after they become available from summer 62 in accordance with the implicit techniques described above.

Mode select unit 40 may also signal a flag for reception by video decoder 30 via entropy encoding unit 56. Mode select unit 40 may include this flag with pictures with temporal level value of 0, and may signal this flag in the slice header, as one example, although model select unit 40 may signal this flag in the picture parameter set (PPS), sequence parameter set (SPS), or any other level. When mode select unit 40 sets the flag to be true, the flag may indicate that all previous short-term pictures are unusable for inter-prediction, except the short-term picture with a temporal level value of 0 that is closest to the current picture in coding order.

It should be understood that description of mode select unit 40 as performing the example techniques described in this disclosure is provided for purposes of illustration and for ease of understanding, and should not be considered limiting. For example, a unit other than mode select unit 40 may implement the examples of the implicit techniques. For instance, a processor (not shown) may implement the techniques. In some examples, various modules or units of video encoder 20 may share the implementation of the examples of the implicit techniques described above.

Intra prediction unit 46 within prediction module 41 may perform intra-predictive coding of the current video block relative to one or more neighboring blocks in the same picture or slice as the current block to be coded to provide spatial compression. Motion estimation unit 42 and motion compensation unit 44 within prediction module 41 perform inter-predictive coding of the current video block relative to one or more predictive blocks in one or more reference pictures to provide temporal compression.

Motion estimation unit 42 and motion compensation unit 44 may be highly integrated, but are illustrated separately for conceptual purposes. Motion estimation, performed by motion estimation unit 42, is the process of generating motion vectors, which estimate motion for video blocks. A motion vector, for example, may indicate the displacement of a video block within a current video picture relative to a predictive block within a reference picture. A predictive block is a block that is found to closely match the video block to be coded in terms of pixel difference, which may be determined by sum of absolute difference (SAD), sum of square difference (SSD), or other difference metrics. In some examples, video encoder 20 may calculate values for sub-integer pixel positions of reference pictures stored in DPB 64. For example, video encoder 20 may calculate values of one-quarter pixel positions, one-eighth pixel positions, or other fractional pixel positions of the reference picture. Therefore, motion estimation unit 42 may perform a motion search relative to the full pixel positions and fractional pixel positions and output a motion vector with fractional pixel precision. In some examples, motion estimation unit 42 may perform the motion search from reference pictures that are marked as “used for reference,” and not from pictures that are marked as “unused for reference” in DPB 64.

Motion estimation unit 42 calculates a motion vector for a video block of an inter-coded video block by comparing the position of the video block to the position of a predictive block of a reference picture. This reference picture may be one of the reference pictures in the reference picture window managed by mode select unit 40. For example, when a video block is uni-directionally predicted, motion estimation unit 42 may use uni-predictive coding for the video block and calculate a single motion vector from one reference picture. In another example, when the video slice is bi-predicted, motion estimation unit 42 may use bi-predictive coding for the video block and calculate two motion vectors from two different reference pictures. These reference pictures may be reference pictures in the reference picture window managed by mode select unit 40.

Motion estimation unit 42 sends the calculated motion vector to entropy encoding unit 56 and motion compensation unit 44. Motion compensation, performed by motion compensation unit 44, may involve fetching or generating the predictive block based on the motion vector determined by motion estimation. Upon receiving the motion vector for the current video block, motion compensation unit 44 may locate the predictive block to which the motion vector points. Video encoder 20 forms a residual video block by subtracting pixel values of the predictive block from the pixel values of the current video block being coded, forming pixel difference values. The pixel difference values form residual data for the block, and may include both luma and chroma difference components. Summer 50 represents the component or components that perform this subtraction operation.

In general, motion compensation unit 44 signals motion vector information for each reference picture from which a current video block is predicted. Motion compensation unit 44 also signals information for the index value or values that indicate where the reference picture or pictures are identified in reference picture lists, sometimes referred to as List 0 and List 1.

In examples where a video block is predicted with respect to single reference picture, motion compensation unit 44 signals the residual between the video block and the matching block of the reference picture. In examples where a video block is predicted with respect to two reference pictures, motion compensation unit 44 may signal the residual between the video block and the matching blocks of the each of the reference pictures. Motion compensation unit 44 may signal this residual or residuals from which video decoder 30 decodes the video block.

After motion compensation unit 44 generates the predictive block for the current video block, video encoder 20 forms a residual video block by subtracting the predictive block from the current video block. Transform module 52 may form one or more transform units (TUs) from the residual block. Transform module 52 applies a transform, such as a discrete cosine transform (DCT) or a conceptually similar transform, to the TU, producing a video block comprising residual transform coefficients. The transform may convert the residual block from a pixel domain to a transform domain, such as a frequency domain.

Transform module 52 may send the resulting transform coefficients to quantization unit 54. Quantization unit 54 quantizes the transform coefficients to further reduce bit rate. The quantization process may reduce the bit depth associated with some or all of the coefficients. The degree of quantization may be modified by adjusting a quantization parameter. In some examples, quantization unit 54 may then perform a scan of the matrix including the quantized transform coefficients. Alternatively, entropy encoding unit 56 may perform the scan.

Following quantization, entropy encoding unit 56 entropy codes the quantized transform coefficients. For example, entropy encoding unit 56 may perform context adaptive variable length coding (CAVLC), context adaptive binary arithmetic coding (CABAC), probability interval partitioning entropy (PIPE), or another entropy encoding technique. Following the entropy encoding by entropy encoding unit 56, the encoded bitstream may be transmitted to a video decoder, such as video decoder 30, or archived for later transmission or retrieval.

Entropy encoding unit 56 may also entropy encode the motion vectors and the other prediction syntax elements for the current video picture being coded. For example, entropy encoding unit 56 may construct header information that includes appropriate syntax elements generated by motion compensation unit 44 for transmission in the encoded bitstream. To entropy encode the syntax elements, entropy encoding unit 56 may perform CABAC and binarize the syntax elements into one or more binary bits based on a context model. Entropy encoding unit may also perform CAVLC and encode the syntax elements as codewords according to probabilities based on context.

Inverse quantization unit 58 and inverse transform module 60 apply inverse quantization and inverse transformation, respectively, to reconstruct the residual block in the pixel domain for later use as a reference block of a reference picture. Motion compensation unit 44 may calculate a reference block by adding the residual block to a predictive block of one of the reference pictures. Motion compensation unit 44 may also apply one or more interpolation filters to the reconstructed residual block to calculate sub-integer pixel values for use in motion estimation. Summer 62 adds the reconstructed residual block to the motion compensated prediction block produced by motion compensation unit 44 to produce a reference picture for storage in DPB 64. The reference picture may be used by motion estimation unit 42 and motion compensation unit 44 as a reference block to inter-predict a block in a subsequent video picture.

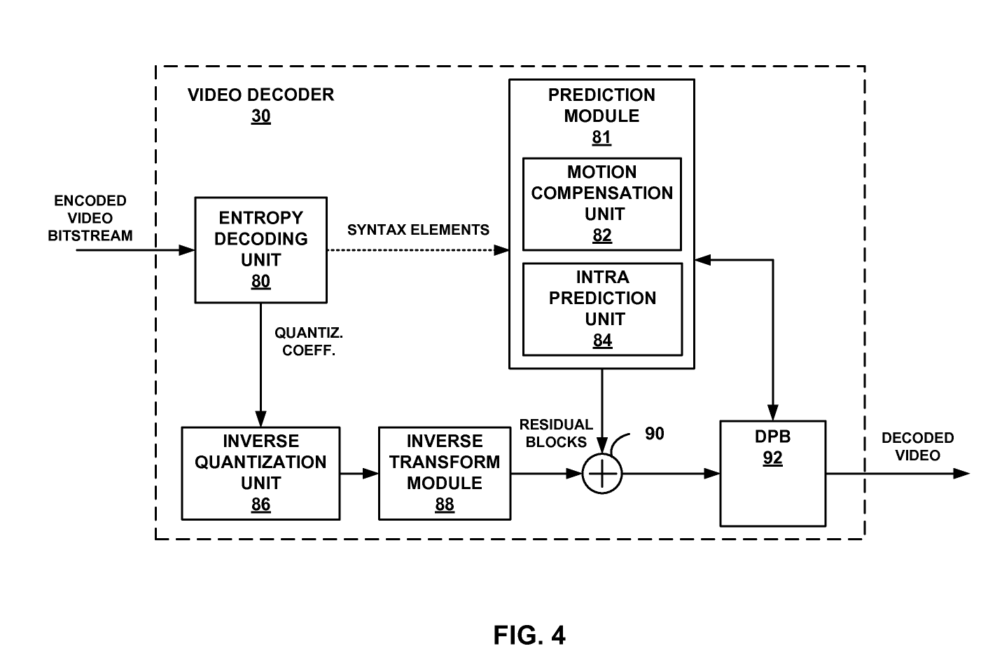

FIG. 4 is a block diagram illustrating an example video decoder 30 that may implement techniques in accordance with one or more aspects of this disclosure. In the example of FIG. 4, video decoder 30 includes an entropy decoding unit 80, prediction module 81, inverse quantization unit 86, inverse transformation unit 88, summer 90, and decoded picture buffer (DPB) 92. Prediction module 81 includes motion compensation unit 82 and intra prediction unit 84. Video decoder 30 may, in some examples, perform a decoding pass generally reciprocal to the encoding pass described with respect to video encoder 20 (FIG. 3).

During the decoding process, video decoder 30 receives an encoded video bitstream that includes an encoded video block and syntax elements that represent coding information from a video encoder, such as video encoder 20. Entropy decoding unit 80 of video decoder 30 entropy decodes the bitstream to generate quantized coefficients, motion vectors, and other prediction syntax. Entropy decoding unit 80 forwards the motion vectors and other prediction syntax to prediction module 81. Video decoder 30 may receive the syntax elements at the video prediction unit level, the video coding unit level, the video slice level, the video picture level, and/or the video sequence level.

When the video slice is coded as an intra-coded (I) slice, intra prediction unit 84 of prediction module 81 may generate prediction data for a video block of the current video picture based on a signaled intra prediction mode and data from previously decoded blocks of the current picture. When the video block is inter-predicted, motion compensation unit 82 of prediction module 81 produces predictive blocks for a video block of the current video picture based on the motion vector or vectors and prediction syntax received from entropy decoding unit 80.

Motion compensation unit 82 determines prediction information for the current video block by parsing the motion vectors and prediction syntax, and uses the prediction information to produce the predictive blocks for the current video block being decoded. For example, motion compensation unit 82 uses some of the received syntax elements to determine sizes of CUs used to encode the current picture, split information that describes how each CU of the picture is split, modes indicating how each split is encoded (e.g., intra- or inter-prediction), motion vectors for each inter-predicted video block of the picture, motion prediction direction for each inter-predicted video block of the picture, and other information to decode the current video picture.

Motion compensation unit 82 may also perform interpolation based on interpolation filters. Motion compensation unit 82 may use interpolation filters as used by video encoder 20 during encoding of the video block to calculate interpolated values for sub-integer pixels of a reference block. Motion compensation unit 82 may determine the interpolation filters used by video encoder 20 from the received syntax elements and use the interpolation filters to produce predictive blocks.

In some examples, prediction module 81 may be implement the example techniques described above. For example, prediction module 81 may manage DPB 92 similarly to the management of DPB 64 described above with respect to FIG. 3. For example, prediction module 81 may implement at least one of the examples of the implicit technique described above to determine whether a reference picture stored in DPB 92, currently indicated to be usable for inter-prediction, is no longer usable for inter-prediction. Prediction module 81 may maintain the reference picture window, and remove and insert pictures into the reference picture window after they become available from summer 90 in accordance with the implicit techniques described above.

Prediction module 81 may also receive a flag signaled from video encoder 20 via entropy decoding unit 80. When prediction module 81 determines that the flag is true, prediction module 81 may determine that all previous short-term pictures stored in DPB 92 are unusable for inter-prediction, except the short-term picture with a temporal level value of 0 that is closest to the current picture in coding order.

It should be understood that prediction module 81 performing the example techniques described in this disclosure is provided for purposes of illustration and for ease of understanding, and should not be considered limiting. For example, a unit other than prediction module 81 may implement the examples of the implicit techniques. For instance, a processor (not shown) may implement the techniques. In some examples, various modules or units of video decoder 30 may share the implementation of the examples of the implicit techniques described above.

Inverse quantization unit 86 inverse quantizes, i.e., de-quantizes, the quantized transform coefficients provided in the bitstream and decoded by entropy decoding unit 80. The inverse quantization process may include use of a quantization parameter QP_{Y} calculated by video encoder 20 for each video block or CU to determine a degree of quantization and, likewise, a degree of inverse quantization that should be applied. Inverse transform module 88 applies an inverse transform, e.g., an inverse DCT, an inverse integer transform, or a conceptually similar inverse transform process, to the transform coefficients in order to produce residual blocks in the pixel domain.

After motion compensation unit 82 generates the predictive block for the current video block based on the motion vectors and prediction syntax elements, video decoder 30 forms a decoded video block by summing the residual blocks from inverse transform module 88 with the corresponding predictive blocks generated by motion compensation unit 82. Summer 90 represents the component or components that perform this summation operation. If desired, a deblocking filter may also be applied to filter the decoded blocks in order to remove blockiness artifacts. The decoded video blocks are then stored in DPB 92, which provides reference blocks of reference pictures for subsequent motion compensation. DPB 92 also produces decoded video for presentation on a display device, such as display device 32 of FIG. 1.

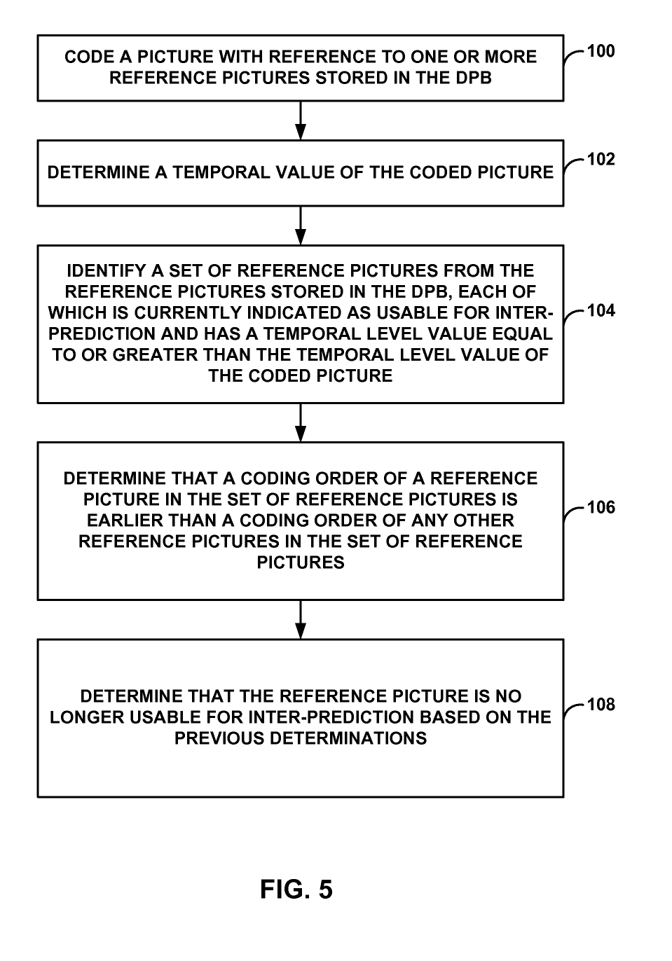

FIG. 5 is a flowchart illustrating an example operation in accordance with one or more aspects of this disclosure. The example illustrated in FIG. 5 may correspond to the first example of the implicit technique. Either or both of video encoder 20 and video decoder 30 may implement the example implicit techniques illustrated in FIG. 5. For purposes of brevity, the example of FIG. 5 is described as being performed by a video coder, examples of which include video encoder 20 and video decoder 30.

The video coder may code (e.g., encode or decode) a picture (100). The video coder may determine a temporal level value of the coded picture (102). In some examples, the video coder may then identify a set of reference pictures from the reference pictures stored in the DPB, each of which is currently indicated as usable for inter-prediction and has a temporal level value equal to or greater than the temporal level value of the coded picture (104). For example, DPB 64 of video encoder 20 or DPB 92 of video decoder 30 may store the reference picture that is currently indicated as being usable for inter-prediction. For instance, the reference picture may be marked as “used for reference.”

The video coder may determine that a coding order, e.g., as indicated by a picture number, of the reference picture is earlier than a coding order of any other reference pictures, that are indicated to be usable for inter-prediction and are stored in the DPB, that have temporal level values that are equal to or greater than the temporal level value of the coded picture (106). For example, the video coder may determine that the picture number value of the reference picture is less than the picture number value of any other reference pictures stored in the DPB that have temporal level values that are equal to or greater than the temporal level value of the coded picture.

The video coder may then determine that the reference picture is no longer usable for inter-prediction based on the previous determinations (108). For example, the video coder may determine that the reference picture is no longer usable for inter-prediction when: (1) the temporal level of the reference picture is equal to or greater than the temporal level value of the coded picture, and (2) the coding order of the reference picture is earlier than the coding order of all other reference pictures that have temporal level values that are equal to or greater than the temporal level value of the coded picture.

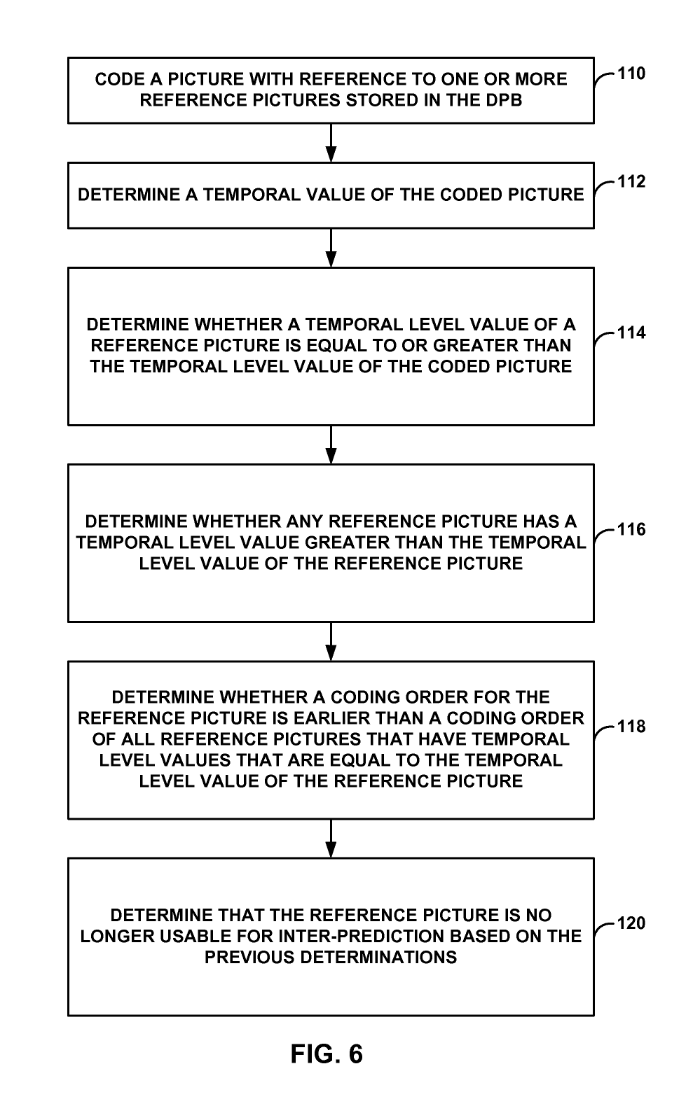

FIG. 6 is a flowchart illustrating an example operation in accordance with one or more aspects of this disclosure. The example illustrated in FIG. 6 may correspond to the second example of the implicit technique. Either or both of video encoder 20 and video decoder 30 may implement the example implicit techniques illustrated in FIG. 6. As with FIG. 5, for purposes of brevity, the example of FIG. 6 is described as being performed by a video coder, examples of which include video encoder 20 and video decoder 30.

Similar to FIG. 5, the video coder may code (e.g., encode or decode) a picture (110). The video coder may determine a temporal level value of the coded picture (112). In some examples, the video coder may then determine whether a temporal level value of a reference picture, that is stored in a DPB and is currently indicated as being usable for inter-prediction, is equal to or greater than the temporal level value of the coded picture (114).

In some examples, the video coder may determine whether any reference picture stored in the DPB has a temporal level value greater than the temporal level value of the reference picture (116). The video coder may also determine whether a coding order for the reference picture is earlier than a coding order of all reference pictures that have temporal level values that are equal to the temporal level value of the reference picture (118).

Based on the previous determinations, the video coder may determine that the reference picture is no longer usable for inter-predication (120). For example, the video coder may determine that the reference picture is no longer usable for inter-prediction when: (1) the temporal level value of the reference picture is equal to or greater than the temporal level value of the coded picture, (2) no other reference picture has a temporal level value greater than the temporal level value of the reference picture, and (3) the coding order for the reference picture is earlier than the coding order of all reference pictures that have temporal level values that are equal to the temporal level value of the reference picture.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

1. A method for video coding comprising:
coding a picture with reference to one or more reference pictures stored in a decoded picture buffer (DPB);
determining a temporal level value of the coded picture;
identifying a set of reference pictures from the reference pictures stored in the DPB, each of which is currently indicated as usable for inter-prediction and has a temporal level value equal to or greater than the temporal level value of the coded picture;
determining that a coding order of a reference picture in the set of reference pictures is earlier than a coding order of any other reference pictures in the set of reference pictures; and
determining that the reference picture is no longer usable for inter-prediction.

2. The method of claim 1, wherein determining the temporal level value of the coded picture comprises setting the temporal level value of the coded picture such that the temporal level value of the coded picture is greater than or equal to the temporal level value of the one or more reference pictures used to code the picture.

3. The method of claim 1, wherein determining the temporal level value of the coded picture comprises receiving the temporal level value of the coded picture.

4. The method of claim 3, wherein receiving the temporal level value of the coded picture comprises receiving the temporal level value of the coded picture in a network abstraction layer (NAL) unit.

5. The method of claim 1, wherein identifying the set of reference pictures from the reference pictures stored in the DPB, each of which is currently indicated as usable for inter-prediction comprising identifying the set of reference pictures from the reference pictures stored in the DPB that are marked as used for reference.

6. The method of claim 1, further comprising:
marking the reference picture as no longer usable for inter-prediction when it is determined that the reference picture is no longer usable for inter-prediction;
indicating that the coded picture is usable for inter-prediction when it is determined that the reference picture is no longer usable for inter-prediction; and
adding the coded picture into the DPB.

7. The method of claim 1, wherein determining that the coding order of the reference picture is earlier than the coding order of any other reference pictures comprises determining that a picture number value of the reference picture is less than a picture number value of any other reference pictures in the set of reference pictures.

8. The method of claim 1, wherein determining that the reference picture is no longer usable for inter-prediction comprises determining that the reference picture is no longer usable for inter-prediction when a total number of reference pictures indicated as usable for inter-prediction equals a threshold value (M).

9. The method of claim 1, wherein coding the picture comprises decoding the picture, wherein determining the temporal level value of the coded picture comprises determining the temporal level value of the decoded picture, and wherein determining that the coding order of the reference picture in the set of reference pictures is earlier than the coding order of any other reference pictures in the set of reference pictures comprises determining that the decoding order of the reference picture is earlier than the decoding order of any other reference pictures in the set of reference pictures.

10. The method of claim 1, wherein coding the picture comprises encoding the picture, wherein determining the temporal level value of the coded picture comprises determining the temporal level value of the encoded picture, and wherein determining whether the coding order of the reference picture in the set of reference pictures is earlier than the coding order of any other reference pictures in the set of reference pictures comprises determining that the encoding order of the reference picture is earlier than the encoding order of any other reference pictures in the set of reference pictures.

11. The method of claim 1, wherein determining that the reference picture is no longer usable for inter-prediction comprises determining that a short-term reference picture is no longer usable for inter-prediction.

12. The method of claim 1, wherein determining that the reference picture is no longer usable for inter-prediction comprises determining that the reference picture is no longer usable for inter-prediction without using syntax elements that define a manner in which the reference picture should be determined to be no longer usable for inter-prediction.

13. A video coding device, comprising:
a decoded picture buffer (DPB) configured to store reference pictures that are currently indicated as usable for inter-prediction; and
a video coder, coupled to the DBP, and configured to:
code a picture with reference to one or more reference pictures stored in the DPB;
determine a temporal level value of the coded picture;
identify a set of reference pictures from the reference pictures stored in the DPB, each of which is currently indicated as usable for inter-prediction and has a temporal level value equal to or greater than the temporal level value of the coded picture;
determine that a coding order of a reference picture in the set of reference pictures is earlier than a coding order of any other reference pictures in the set of reference pictures; and
determine that the reference picture is no longer usable for inter-prediction.

14. The video coding device of claim 13, wherein, to determine the temporal level value of the coded picture, the video coder is configured to set the temporal level value of the coded picture such that the temporal level value of the coded picture is greater than or equal to the temporal level value of the one or more reference pictures used to code the picture.

15. The video coding device of claim 13, wherein, to determine the temporal level value of the coded picture, the video coder is configured to receive the temporal level value of the coded picture.

16. The video coding device of claim 15, wherein the video coder is configured to receive the temporal level value of the coded picture in a network abstraction layer (NAL) unit.

17. The video coding device of claim 13, wherein, to identify the set of reference pictures from the reference pictures stored in the DPB, each of which is currently indicated as usable for inter-prediction, the video coder is configured to identify the set of reference pictures from the reference pictures stored in the DPB that are marked as used for reference.

18. The video coding device of claim 13, wherein the video coder is configured to:
mark the reference picture as no longer usable for inter-prediction when it is determined that the reference picture is no longer usable for inter-prediction;
indicate that the coded picture is usable for inter-prediction when the video coder determined that the reference picture is no longer usable for inter-prediction; and
add the coded picture into the DPB.

19. The video coding device of claim 13, wherein the video coder is configured to determine that a picture number value of the reference picture is less than a picture number value of any other reference pictures that have temporal level values that are equal to or greater than the temporal level value of the coded picture to determine that the coding order of the reference picture is earlier than the coding order of any other reference pictures in the set of reference pictures.

20. The video coding device of claim 13, wherein the video coder is configured to determine that the reference picture is no longer usable for inter-prediction when a total number of reference pictures indicated as usable for inter-prediction equals a threshold value (M).

21. The video coding device of claim 13, wherein the video coder comprises a video decoder, wherein the coded picture comprises a decoded picture, and wherein the video decoder is configured to determine that a decoding order of the reference picture is earlier than a decoding order of any other reference pictures in the set of reference pictures.

22. The video coding device of claim 13, wherein the video coder comprises a video encoder, wherein the coded picture comprises an encoded picture, wherein the video encoder is configured to determine that an encoding order of the reference picture is earlier than an encoding order of any other reference pictures in the set of reference pictures

23. The video coding device of claim 13, wherein the video coder is configured to determine that a short-term reference picture is no longer usable for inter-prediction.

24. The video coding device of claim 13, wherein the video coder is configured to determine that the reference picture is no longer usable for inter-prediction without coding syntax elements that define a manner in which the reference picture should be determined to be no longer usable for inter-prediction.

25. A computer-readable storage medium comprising instructions that cause one or more processors to:
code a picture with reference to one or more reference pictures stored in a decoded picture buffer (DPB);
determine a temporal level value of the coded picture;
identify a set of reference pictures from the reference pictures stored in the DPB, each of which is currently indicated as usable for inter-prediction and has a temporal level value equal to or greater than the temporal level value of the coded picture;
determine that a coding order of a reference picture in the set of reference pictures is earlier than a coding order of any other reference pictures in the set of reference pictures; and
determine that the reference picture is no longer usable for inter-prediction.

26. The computer-readable storage medium of claim 25, further comprising instructions that cause the one or more processors to:
mark the reference picture as no longer usable for inter-prediction when it is determined that the reference picture is no longer usable for inter-prediction;
indicate that the coded picture is usable for inter-prediction when it is determined that the reference picture is no longer usable for inter-prediction; and
add the coded picture into the DPB.

27. The computer-readable storage medium of claim 25, wherein the instructions that cause the one or more processors to determine that the coding order of the reference picture is earlier than the coding order of any other reference pictures comprise instructions that cause the one or more processors to determine that a picture number value of the reference picture is less than a picture number value of any other reference pictures in the set of reference pictures.

28. The computer-readable storage medium of claim 25, wherein the instructions that cause the one or more processors to determine that the reference picture is no longer usable for inter-prediction comprise instructions that cause the one or more processors to determine that the reference picture is no longer usable for inter-prediction when a total number of reference pictures indicated as usable for inter-prediction equals a threshold value (M).

29. The computer-readable storage medium of claim 25, wherein the instructions that cause the one or more processors to determine that the reference picture is no longer usable for inter-prediction comprise instructions that cause the one or more processors to determine that a short-term reference picture is no longer usable for inter-prediction.

30. A video coding device comprising:
a decoded picture buffer configured to store reference pictures that are currently indicated as usable for inter-prediction;
means for coding a picture with reference to one or more reference pictures stored in the DPB;
means for determining a temporal level value of the coded picture;
means for identifying a set of reference pictures from the reference pictures stored in the DPB, each of which is currently indicated as usable for inter-prediction and has a temporal level value equal to or greater than the temporal level value of the coded picture;
means for determining that a coding order of a reference picture in the set of reference pictures is earlier than a coding order of any other reference pictures in the set of reference pictures; and
means for determining that the reference picture is no longer usable for inter-prediction.

31. The video coding device of claim 30, wherein the means for determining that the coding order of the reference picture is earlier than the coding order of any other reference pictures comprises means for determining that a picture number value of the reference picture is less than a picture number value of any other reference pictures in the set of reference pictures.

32. The video coding device of claim 30, wherein the means for determining that the reference picture is no longer usable for inter-prediction comprises means for determining that the reference picture is no longer usable for inter-prediction when a total number of reference pictures indicated as usable for inter-prediction equals a threshold value (M).
